(19) United States
(12) Patent Application Publication
(10) Pub. No.: US 2016/0086700 A1
(43) Pub. Date: Mar. 24, 2016

(54) METHOD FOR PRODUCING MAGNETIC MATERIAL

(71) Applicant: Kabushiki Kaisha Toshiba, Minato-ku (JP)

(72) Inventors: Tomohiro SUETSUNA, Kawasaki (JP); Koichi HARADA, Bunkyo (JP); Tomoko EGUCHI, Yokohama (JP); Toshihide TAKAHASHI, Yokohama (JP); Seiichi SUENAGA, Yokohama (JP)

(73) Assignee: Kabushiki Kaisha Toshiba, Minato-ku (JP)

(21) Appl. No.: 14/843,169

(22) Filed: Sep. 2, 2015

(30) Foreign Application Priority Data
Sep. 19, 2014 (JP) 2014-192013

(51) Int. Cl. H01F 1/01

(52) U.S. Cl. CPC H01F 1/01

(57) ABSTRACT

Provided is a method for producing a magnetic material, the method including preparing a mixed phase material including a first magnetic metal phase formed from a magnetic metal and a second phase containing any one of oxygen (O), nitrogen (N) or carbon (C) and a non-magnetic metal, conducting a first heat treatment to the mixed phase material at a temperature of from 50° C. to 800° C., forming nanoparticle aggregates including a plurality of magnetic metal nanoparticles formed from the first magnetic metal phase and the second phase, and conducting a second heat treatment to the nanoparticle aggregates at a temperature of from 50° C. to 800° C. The nanoparticle aggregates are formed by decreasing an average particle size and a particle size distribution variation of the first magnetic metal phase after the first heat treatment.

### CROSS-REFERENCE TO RELATED APPLICATION

This application is based upon and claims the benefit of priority from Japanese Patent Application No. 2014-192013, filed on Sep. 19, 2014, the entire contents of which are incorporated herein by reference.

### FIELD

Embodiments described herein relate generally to a method for producing a magnetic material.

### BACKGROUND

Currently, magnetic materials are being applied to the component parts of various devices such as inductor elements, electromagnetic wave absorbers, magnetic inks, and antenna apparatuses. These component parts utilize the characteristics of the real part of the magnetic permeability (real part of the relative magnetic permeability) μ′ or the imaginary part of the magnetic permeability (imaginary part of the relative magnetic permeability) μ″ possessed by magnetic materials, according to the purpose. For example, inductance elements or antenna devices utilize high μ′ (and low μ″), while electromagnetic wave absorbers utilize high μ″. For this reason, in a case in which such component parts are actually used in devices, it is preferable that the characteristics μ′ and μ″ be controlled in accordance with the working frequency band in the equipment.

In recent years, adjustment of the working frequency band in the equipment to higher frequency bands is in progress, and there is an urgent need for the development of a magnetic material having excellent characteristics with high μ′ and low μ″ at high frequencies.

Magnetic materials having high μ′ and low μ″ are used in inductance elements, antenna apparatuses and the like; however, among them, particular attention has been paid in recent years to the application of the magnetic materials in power inductance elements that are used in power semiconductors. In recent years, the importance of energy saving and environment protection has been actively advocated, and there have been demands for the abatement of CO₂ emission and a decrease in the dependency on fossil fuels.

As a result, development of electric vehicles and hybrid vehicles that substitute gasoline vehicles is in active progress. Also, the technologies for utilizing natural energies such as solar power generation and wind power generation are regarded as key technologies to an energy-saving society, and various developed countries have actively promoted the development of technologies for utilizing natural energies. Furthermore, as an environment-friendly electric power saving system, the importance of establishment of home energy management systems (HEMS) and building and energy management systems (BEMS) that control the electric power generated by solar power generation, wind power generation and the like through smart grids, and supply the electric power to homes, offices and industrial plants at high efficiency, is being actively advocated.

In such a trend for energy savings, power semiconductors play a key role. Power semiconductors are semiconductors which control high electric power or energy with high efficiency, and include power discrete semiconductors such as insulated gate bipolar transistors (IGBT), metal oxide semiconductor field-effect transistors (MOSFET), power bipolar transistors, and power diodes, as well as power supply circuits such as linear regulators and switching regulators, and logic large scale integration (LSI) for power management to control these devices.

Power semiconductors are widely used in all equipment in the applications of electrical appliances, computers, automobiles, railway transportation and the like, and there can be expected an increase in the distribution of these applied instruments and an increase in the mounting ratios of power semiconductors in these instruments. Therefore, an extensive growth in the market for power semiconductors in the future is anticipated. For example, in the inverters that are mounted in many electrical appliances, power semiconductors are used to an extent that may well be said to be almost the entirety of the inverters, and extensive energy saving is made possible thereby.

Currently, silicon (Si) constitutes the mainstream of power semiconductors; however, it is believed that for the purpose of an enhancement of efficiency and miniaturization of instruments, it is effective to use SiC and GaN. SiC or GaN has a larger band gap or a larger dielectric breakdown electric field than Si, and since SiC or GaN can increase the withstand voltage, the thickness of elements can be decreased. Accordingly, the on-resistance of semiconductors can be decreased, and these substances are effective in decreasing losses and increasing efficiency. Furthermore, since SiC or GaN has higher carrier mobility, the switching frequency can be adjusted to high frequencies, and it is effective for the miniaturization of elements. Moreover, particularly, since SiC has higher thermal conductivity than Si, SiC has higher thermal dissipation capacity and enables operation at high temperatures. Thus, simplification of the cooling mechanism can be achieved, and this is effective in miniaturization of elements.

From the viewpoints described above, development of SiC and GaN power semiconductors is in active progress. In order to realize the development, the development of power inductor elements that are used together with power semiconductors, that is, the development of high permeability magnetic materials (high μ′ and low μ″), is underway. In this case, regarding the characteristics required from magnetic materials, high magnetic permeability in the driving frequency band, low magnetic losses, as well as high saturation magnetization capable of coping with large electric currents are preferred. If the saturation magnetization is high, it is not easy to induce magnetic saturation even if a high magnetic field is applied, and an effective decrease in the inductance value can be suppressed. Thereby, the direct current superimposition characteristics of devices are enhanced, and the efficiency of systems is enhanced.

Examples of a magnetic material for systems of several kilowatt (kW)-class at 10 kHz to 100 kHz include Sendust (Fe—Si—Al), nanocrystalline Finemet (Fe—Si—B—Cu—Nb), ribbons and pressed powders of Fe-based/Co-based amorphous glass, and MnZn-based ferrite materials. However, all of them do not satisfy characteristics such as high magnetic permeability, low loss, high saturation magnetization, high thermal stability, and high oxidation resistance, and are therefore not satisfactory.

Furthermore, it is anticipated that the driving frequency of systems will be further adjusted to higher frequencies in the future, along with the popularization of SiC and GaN semiconductors, and characteristics such as high magnetic permeability and low loss in the megahertz (MHz) range of 100 kHz or higher are preferred. Therefore, there is a demand for the development of a magnetic material which satisfies high magnetic permeability and low loss in the MHz range of 100 kHz or higher, while satisfying high saturation magnetization, high thermal stability and high oxidation resistance.

Furthermore, a magnetic material having high μ′ and low μ″ at a high frequency is also expected to be applicable to the devices of high frequency communication equipment, such as antenna apparatuses. As a method for decreasing the size of antennas and saving more electric power, there is available a method of dragging electromagnetic waves that reach an electronic component part or a substrate in a communication instrument from an antenna by using an insulating substrate having high magnetic permeability (high μ′ and low μ″) as an antenna substrate, and achieving transmission and reception of electromagnetic waves without allowing the electromagnetic waves to reach the electronic component part or substrate. Thereby, size reduction of antennas and electric power saving are enabled, and at the same time, broadbanding of the resonance frequency of antennas is also enabled, which is preferable.

Even for such applications, in the event that a magnetic material for power inductor elements described above has been developed, there is a possibility that the magnetic material may be applied to the applications, and thus it is preferable.

Furthermore, in electromagnetic wave absorbers, noises generated from electronic equipment are absorbed by utilizing high μ″, and thus inconveniences such as malfunction of electronic equipment are reduced. Examples of the electronic equipment include semiconductor elements such as integrated circuit (IC) chips, and various communication instruments. Such electronic equipment is used in various frequency bands, and high μ″ in a predetermined frequency band is demanded. Generally, a magnetic material has high μ″ near a ferromagnetic resonance frequency. However, if various magnetic losses other than the ferromagnetic resonance loss, for example, the eddy current loss and the magnetic domain wall resonance loss, can be suppressed, μ″ can be decreased while μ′ can be increased, in a frequency band sufficiently lower than the ferromagnetic resonance frequency.

That is, even a single material may be used as a high permeability component part, or may be used as an electromagnetic wave absorber, by changing the working frequency band. Therefore, in the event that a magnetic material for power inductors described above has been developed, even in an application for electromagnetic wave absorbers utilizing μ″, there is a possibility that the magnetic material may be applied by adjusting the ferromagnetic resonance frequency to the frequency band of use.

On the other hand, a material that is developed as an electromagnetic wave absorber is usually designed so as to have maximized μ″ by summing up all the losses composed of various magnetic losses such as the ferromagnetic resonance loss, the eddy current loss, and the magnetic domain wall resonance loss. For this reason, it is not preferable to use a material that is developed as an electromagnetic wave absorber, as a high permeability component part (high μ′ and low μ″) for the inductor elements and antenna apparatuses, even in any frequency band.

Electromagnetic wave absorbers have been conventionally produced by a binding molding method of mixing ferrite particles, carbonyl iron particles, FeAlSi flakes, FeCrAl flakes and the like with a resin. However, all of these materials have extremely low μ′ and μ″ in high frequency bands, and do not necessarily give satisfactory characteristics. In addition to that, materials that are synthesized by a mechanical alloying method or the like have a problem that the long-term thermal stability is insufficient, and the product yield is low.

As discussed above, various materials have been suggested hitherto as the magnetic materials to be used in power inductor elements, antennas, and electromagnetic absorbers.

### BRIEF DESCRIPTION OF THE DRAWINGS

FIGS. 1A and 1B are schematic diagrams of a composite magnetic material of a first embodiment of the invention.

FIGS. 2A to 2C are schematic diagrams illustrating the changes of characteristics in the various steps of the first embodiment.

FIGS. 3A and 3B are schematic diagrams of a composite magnetic material of a second embodiment.

FIGS. 4A and 4B are schematic diagrams of a composite magnetic material of a third embodiment.

FIGS. 5A and 5B are schematic diagrams of inductance elements of a fourth embodiment.

FIGS. 6A and 6B are schematic diagrams of inductance elements of the fourth embodiment.

FIG. 7 is a schematic diagram of a transformer structure of the fourth embodiment.

### DETAILED DESCRIPTION

### First Embodiment

The method for producing a composite magnetic material of the present embodiment includes preparing a mixed phase material including a first magnetic metal phase formed from a magnetic metal and a second phase containing anyone of oxygen (O), nitrogen (N) or carbon (C) and a non-magnetic metal; conducting a first heat treatment to the mixed phase material at a temperature of from 50° C. to 800° C.; forming nanoparticle aggregates including a plurality of magnetic metal nanoparticles formed from the first magnetic metal phase and the second phase, the nanoparticle aggregates being formed by decreasing an average particle size and a particle size distribution variation of the first magnetic metal phase after the first heat treatment; and conducting a second heat treatment to the nanoparticle aggregates at a temperature of from 50° C. to 800° C.

Hereinafter, embodiments will be explained using the attached drawings. Meanwhile, identical or similar symbols have been assigned to identical or similar parts in the drawings.

When the production method of the present embodiment is used, a composite magnetic material formed from nanoparticle aggregates that contain magnetic metal nanoparticles containing magnetic metal, and an interstitial phase (second phase) existing between the magnetic metal nanoparticles and containing a non-magnetic metal and any one of oxygen (O), nitrogen (N) or carbon (C), can be produced with high product yield and in a state of having high stability over time. Furthermore, in regard to the nanoparticle aggregates (composite magnetic material) thus obtainable, since the average particle size, the particle distribution variation and the crystal strain of the magnetic metal nanoparticles can be decreased, particularly magnetic characteristics of high magnetic permeability and low magnetic losses may be easily obtained. Furthermore, not only excellent magnetic characteristics such as high saturation magnetization, high magnetic permeability and low magnetic losses can be realized, but excellent mechanical characteristics such as high strength and high toughness can also be realized.

The production method of the present embodiment is particularly effective in a case in which a composite magnetic material such as described below is produced. That is, a composite magnetic material including magnetic particles, which are particle aggregates containing magnetic metal nanoparticles that have an average particle size of from 1 nm to 100 nm, preferably from 1 nm to 20 nm, and more preferably from 1 nm to 10 nm, and contain at least one magnetic metal selected from the group consisting of Fe, Co and Ni; and an interstitial phase that is present between the magnetic metal nanoparticles and contains at least one non-magnetic metal selected from Mg, Al, Si, Ca, Zr, Ti, Hf, Zn, Mn, Ba, Sr, Cr, Mo, Ag, Ga, Sc, V, Y, Nb, Pb, Cu, In, Sn and rare earth elements, and any one of oxygen (O), nitrogen (N) or carbon (C), the particle aggregates having a shape with an average short dimension of from 10 nm to 2 μm, and preferably from 10 nm to 100 nm, and an average aspect ratio of from 5 to 1000, and preferably from 10 to 1000, and in which particles the volume packing ratio of the magnetic metal nanoparticles relative to the entirety of the particle aggregates is from 40 vol % to 80 vol %, can be produced with high product yield and in a state of having high stability over time.

The present production method is a production method adequate for synthesizing a composite magnetic material in which the average interparticle distance of the magnetic metal nanoparticles is from 0.1 nm to 5 nm. The magnetic metal nanoparticles have an average particle size of from 1 nm to 100 nm, preferably from 1 nm to 20 nm, and more preferably from 1 nm to 10 nm. If the average particle size is adjusted to be less than 1 nm, there is a risk that superparamagnetism may occur and the amount of magnetic flux may be decreased. On the other hand, if the average particle size is more than 10 nm, it is not preferable because the magnetic interaction through magnetic exchange coupling becomes weak. The most preferred particle size range for enhancing the magnetic interaction between particles while maintaining a sufficient amount of magnetic flux, is from 1 nm to 10 nm.

In regard to the average particle size of the magnetic metal nanoparticles described above, the average particle size can be determined by observing a large number of particles with a transmission electron microscope (TEM) and averaging the particle sizes of the particles; however, when it is difficult to determine the particle size by TEM, the particle size can be substituted by the crystal grain size that can be determined from an X-ray diffraction (XRD) analysis. That is, the crystal grain size can be determined by XRD using Scherrer's formula from the diffraction angle and the full width at half maximum in connection with the maximum peak among the peaks attributable to magnetic metals. Scherrer's formula is represented by D=0.9λ/(β cos θ), in which D represents the crystal grain size; λ represents the wavelength of the X-ray used for measurement; β represents the full width at half maximum; and θ represents the Bragg diffraction angle. However, in regard to the crystal grain size analysis based on Scherrer's formula by XRD, it should be noted that an accurate analysis is difficult in the case of a particle size of approximately 50 nm or more. In general, in the case of a particle size of approximately 50 nm or more, caution should be taken in determining the particle size through observation by TEM.

The magnetic metal nanoparticles may be in any of a polycrystalline form or a single crystalline form; however, it is preferable that the magnetic metal nanoparticles be single crystalline. In the case of single crystalline magnetic metal nanoparticles, alignment of the axis of easy magnetization is facilitated, and magnetic anisotropy can be controlled. For this reason, the high frequency characteristics can be enhanced as compared with the case of polycrystalline magnetic metal nanoparticles.

Furthermore, the magnetic metal nanoparticles may have a spherical shape; however, the magnetic metal nanoparticles may also have a flat shape or a rod shape, both of which have large aspect ratios. Particularly, it is preferable that the average of the aspect ratio be 2 or more, more preferably 5 or more, and even more preferably 10 or more. In the case of magnetic metal nanoparticles having a large aspect ratio, it is more desirable to make the longer side direction (in the case of a plate shape, the width direction; in the case of an oblate ellipsoid, the diameter direction; in the case of a rod shape, the length direction of the rod; and in the case of a spheroid, the major axis direction) of individual magnetic metal nanoparticles to coincide with the longer side direction (in the case of a plate shape, the width direction; in the case of an oblate ellipsoid, the diameter direction; in the case of a rod shape, the length direction of the rod; and in the case of a spheroid, the major axis direction) of the magnetic particles (particle aggregates). Thereby, the directions of the axes of easy magnetization can be aligned, and the magnetic permeability and the high frequency characteristics of the magnetic permeability can be enhanced.

Furthermore, it is preferable that the magnetic metal nanoparticles form a nanoparticle aggregate structure in which the magnetic metal nanoparticles are in point contact or in surface contact, and this nanoparticle aggregate structure be primarily oriented in a certain single direction within the particle aggregate. More preferably, it is more preferable that the particle aggregates have a flat shape, a plurality of magnetic metal nanoparticles be brought into contact and form a rod-shaped nanoparticle aggregate structure, and the nanoparticle aggregate structure be primarily oriented in a certain single direction within a flat plane of the particle aggregate. Furthermore, a larger aspect ratio of the nanoparticle aggregate structure is more preferable, and the average of the aspect ratios is preferably 2 or more, more preferably 5 or more, and even more preferably 10 or more.

Here, on the occasion of calculating the aspect ratio of the nanoparticle aggregate structure, the shape of the nanoparticle aggregate structure is defined as follows. That is, in a case in which magnetic metal nanoparticles are in point contact or in surface contact and thereby form a single nanoparticle aggregate structure, the contour line of the nanoparticle aggregate structure is produced such that the contour line surrounds all the magnetic metal nanoparticles included in the single nanoparticle aggregate structure. However, in a case in which a contour line of a neighboring magnetic metal nanoparticles is drawn from the contour line of a single magnetic metal nanoparticles, the contour line is drawn as a tangent line of both the magnetic metal nanoparticles. For example, in a case in which a number of spherical magnetic metal nanoparticles having the same particle size are in point contact in a linear form and form a nanoparticle aggregate structure, the nanoparticle aggregate structure becomes a nanoparticle aggregate structure having a linear rod shape. When the shape of a nanoparticle aggregate structure is defined as described above, the aspect ratio refers to the ratio of the dimension of the structure in the direction in which the length of the nanoparticle aggregate structure becomes the longest (long dimension), to the dimension of the particle in a direction perpendicular to the aforementioned direction, in which the length of the nanoparticle aggregate structure becomes the shortest (short dimension), that is, the ratio of “long dimension/short dimension”. Therefore, the aspect ratio is always 1 or higher. In the case of a perfect spherical shape, since both the long dimension and the short dimension are identical to the diameter of the sphere, the aspect ratio is 1. The aspect ratio of a flat shape is the ratio of diameter (long dimension)/height (short dimension). The aspect ratio of a rod shape is the ratio of the length of the rod (long dimension)/the diameter of the bottom of the rod (short dimension). However, the aspect ratio of a spheroid is the ratio of major axis (long dimension)/minor axis (short dimension). Whether a nanoparticle aggregate structure is primarily oriented in a certain single direction within the particle aggregate, can be determined by performing an image analysis on observation images obtained by TEM. For example, the following method may be employed. First, the long dimension and the short dimension of a nanoparticle aggregate structure are determined by the method described above, the direction of a certain single reference line is determined, and thereby it is determined at which angle each of individual nanoparticle aggregate structures is oriented with respect to the reference line (angle of orientation). This is performed on a large number of nanoparticle aggregate structures, and the abundances of nanoparticle aggregate structures for the respective angles of orientation are determined. Thus, it is determined whether the nanoparticle aggregate structures are oriented in a certain single direction, as compared with the case of random orientation (not oriented). An analysis such as described above can also be carried out by an image analysis using Fourier transformation. By adopting a configuration such as described above, the directions of the axes of easy magnetization can be aligned into one direction, and the magnetic permeability and the high frequency characteristics of the magnetic permeability can be enhanced, which is preferable.

Furthermore, it is preferable that an interstitial phase having a resistivity of 1 mΩ·cm or more and containing at least one non-magnetic metal selected from Mg, Al, Si, Ca, Zr, Ti, Hf, Zn, Mn, Ba, Sr, Cr, Mo, Ag, Ga, Sc, V, Y, Nb, Pb, Cu, In, Sn and rare earth elements and any one of oxygen (O), nitrogen (N) or carbon (C), exist between the magnetic metal nanoparticles. These non-magnetic metals are elements which have small standard Gibbs energy of formation of oxides and are therefore susceptible to oxidation, and these non-magnetic metals are preferably metals that can easily form stable oxides, which is preferable. When a metal, a semiconductor, an oxide, a nitride, a carbide or a fluoride containing such a non-magnetic metal is present between the magnetic metal nanoparticles, the electrical insulating properties between the magnetic metal nanoparticles can be further enhanced, and the thermal stability of the magnetic metal nanoparticles can be enhanced, which is preferable.

Furthermore, it is preferable that the interstitial phase of a metal, a semiconductor, an oxide, a nitride, a carbide or a fluoride contain at least one of the magnetic metals described above. When the metal, semiconductor, oxide, nitride, carbide or fluoride contains at least one of metals that are the same as the magnetic metals contained in the magnetic metal nanoparticles, thermal stability and oxidation resistance are enhanced. Furthermore, when ferromagnetic components exist between the magnetic metal nanoparticles, the magnetic interaction between magnetic metal nanoparticles becomes stronger. For this reason, the magnetic metal nanoparticles and the interstitial phase can behave like magnetic aggregates, and the magnetic permeability and the high frequency characteristics of the magnetic permeability can be enhanced.

Furthermore, similarly, when the interstitial phase of a metal, a semiconductor, an oxide, a nitride, a carbide or a fluoride contains at least one of non-magnetic metals that are the same as the non-magnetic metals contained in the magnetic metal nanoparticles, it is preferable because thermal stability and oxidation resistance are enhanced. Meanwhile, when the interstitial phase contains at least one each of the magnetic metals and the non-magnetic metals contained in the magnetic metal nanoparticles, it is desirable that the atom ratio of non-magnetic metal/magnetic metal in the interstitial phase be larger than the atom ratio of non-magnetic metal/magnetic metal contained in the magnetic metal nanoparticles. This is because the magnetic metal nanoparticles can be blocked by the “interstitial phase having a high ratio of non-magnetic metal/magnetic metal”, which has high oxidation resistance and high thermal stability, and thus the oxidation resistance and thermal stability of the magnetic metal nanoparticles can be effectively increased.

Furthermore, it is desirable that the content of oxygen contained in the interstitial phase be larger than the content of oxygen in the magnetic metal nanoparticles. This is because the magnetic metal nanoparticles can be blocked by the “interstitial phase having a high oxygen concentration and having high oxidation resistance and thermal stability”, and thus the oxidation resistance and thermal stability of the magnetic metal nanoparticles can be effectively increased. Among a metal, a semiconductor, an oxide, a nitride, a carbide and a fluoride, an oxide is more preferred from the viewpoint of thermal stability. The interstitial phase of a metal, an oxide, a nitride, a carbide or a fluoride may be in a particulate form. In the case of an interstitial phase adopting a particulate form, it is desirable that the particles of the interstitial phase be particles having a particle size smaller than the particle size of the magnetic metal nanoparticles. In this case, the particles may be oxide particles, may be nitride particles, may be carbide particles, or may be fluoride particles. However, from the viewpoint of thermal stability, it is more preferable that the particles be oxide particles.

In the following descriptions, the case in which the entirety of the interstitial phase includes oxide particles will be described as an example. Meanwhile, a more preferred state of existence of the oxide particles is a state in which the oxide particles are uniformly and homogeneously dispersed between the magnetic metal nanoparticles. Thereby, more uniform magnetic characteristics and dielectric characteristics can be expected. These oxide particles can not only enhance the oxidation resistance and the aggregation inhibitory power of the magnetic metal nanoparticles, that is, the thermal stability of the magnetic metal nanoparticles, but also can increase the electrical resistance of the particle aggregates and the magnetic material by electrically separating the magnetic metal nanoparticles. When the electrical resistance of the magnetic material is increased, the eddy current loss at a high frequency is suppressed, and thus the high frequency characteristics of the magnetic permeability can be enhanced. For this reason, it is preferable that the oxide particles have high electrical resistance, and preferably have a resistance value of, for example, 1 Ω·cm or more.

The oxide particles contain at least one non-magnetic metal selected from the group consisting of Mg, Al, Si, Ca, Zr, Ti, Hf, Zn, Mn, Ba, Sr, Cr, Mo, Ag, Ga, Sc, V, Y, Nb, Pb, Cu, In, Sn, and rare earth elements. These non-magnetic metals are elements which have small standard Gibbs energy of formation of oxides and are therefore susceptible to oxidation, and these non-magnetic metals can easily form stable oxides. Also, in a case in which the magnetic metal nanoparticles include a coating layer, it is preferable that the ratio of non-magnetic metal/magnetic metal (atom ratio) in these oxide particles be larger than the ratio of non-magnetic metal/magnetic metal (atom ratio) in the coating layer that covers the magnetic metal nanoparticles. As such, when the proportion of non-magnetic metals is high, the oxide particles become more thermally stable than the coating layer. Accordingly, when such oxide particles are present at least in a portion of the space between the magnetic metal nanoparticles, the electrical insulating properties between the magnetic metal nanoparticles can be further enhanced, and the thermal stability of the magnetic metal nanoparticles can be enhanced. Meanwhile, the oxide particles may not contain magnetic metals; however, more preferably, it is desirable that the oxide particles contain magnetic metals. A preferred amount of the magnetic metals included therein is 0.001 atom % or more, and preferably 0.01 atom % or more, with respect to the non-magnetic metals. This is because if the oxide particles do not contain magnetic metals at all, the constituent components of the coating layer that covers the surface of the magnetic metal nanoparticles and the constituent components of the oxide particles completely differ from each other, which is not so preferable from the viewpoints of adhesiveness and strength, and there is a possibility that thermal stability may be rather deteriorated. Furthermore, if the oxide particles existing between the magnetic metal nanoparticles do not contain magnetic metals at all, it is difficult for the magnetic metal nanoparticles to simultaneously magnetically bind to one another, and it is not preferable from the viewpoint of the magnetic permeability and the high frequency characteristics of the magnetic permeability. Therefore, more preferably, it is desirable that the oxide particles contain at least one of the magnetic metals which are constituent components of the magnetic metal nanoparticles and are also constituent components of the oxide coating layer, and even more preferably, it is desirable that the ratio of non-magnetic metal/magnetic metal (atom ratio) in the oxide particles be larger than the ratio of non-magnetic metal/magnetic metal (atom ratio) in the oxide coating layer. Meanwhile, it is more preferable that the oxide particles be oxide particles containing non-magnetic metals of the same kinds as the non-magnetic metals contained in the magnetic metal nanoparticles and of the same kinds as the non-magnetic metals contained in the oxide coating layer. It is because when the oxide particles are oxide particles containing non-magnetic metals of the same kinds, the thermal stability and the oxidation resistance of the magnetic metal nanoparticles are further enhanced. Incidentally, the thermal stability enhancing effect, electrical insulating properties effect, and the adhesiveness and strength enhancing effect of the oxide particles described above are manifested particularly when the average particle size of the magnetic metal nanoparticles is small, and it is particularly effective in a case in which the oxide particles have a particle size smaller than the particle size of the magnetic metal nanoparticles. Furthermore, it is preferable that the volume packing ratio of the magnetic metal nanoparticles be from 30 vol % to 80 vol % relative to the total amount of the particle aggregates. The volume packing ratio is more preferably from 40 vol % to 80 vol %, and even more preferably from 50 vol % to 80 vol %.

In the composite magnetic material formed from such particle aggregates, the magnetic metal nanoparticles can easily magnetically bind to one another, and thus magnetically behave as a single aggregate. For this reason, the coercivity is likely to be decreased, accordingly the magnetic permeability is likely to be increased, and the hysteresis loss is likely to be decreased. On the other hand, since the interstitial phase having high electrical resistance, for example, oxides are present between the particles of the magnetic metal nanoparticles, in view of electrical characteristics, the electrical resistance of the composite magnetic material can be made larger. Therefore, the eddy current loss can be suppressed while high magnetic permeability is maintained, which is preferable.

Next, the production method according to the present embodiment will be explained in detail. First, the production method according to the present embodiment begins with a first step of preparing a mixed phase material including a first magnetic metal phase formed from a magnetic metal and of a second phase containing any one of oxygen (O), nitrogen (N) or carbon (C) and a non-magnetic metal. The mixed phase material refers to a material having at least two or more phases such as a metal phase and an oxide phase, a metal phase and a nitride phase, or a metal phase and a carbide phase. Furthermore, the any one element of oxygen (O), nitrogen (N) or carbon (C) contained in the magnetic metals may be any of them; however, oxygen (O) is more preferable from the viewpoints of thermal stability and oxidation resistance. Hereinafter, mainly the case in which the element is oxygen (O) will be explained as an example.

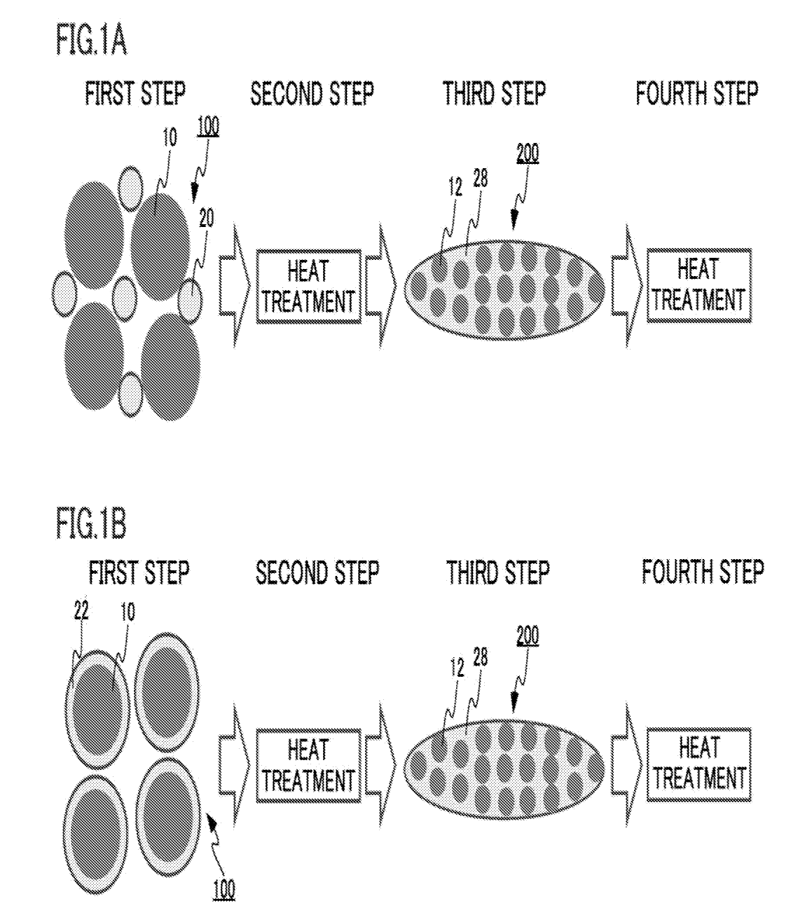

FIGS. 1A and 1B are schematic diagrams of a composite magnetic material of a first embodiment. In regard to the first step, in the mixed phase material 100, the first magnetic metal phase is in the form of particles that serve as the magnetic metal particles. In this case, a configuration in which, as shown in FIG. 1A, the first magnetic metal phase is formed from a plurality of magnetic metal particles 10, and the second phase is formed from a plurality of particles 20, may be adopted, or a configuration of core-shell type particles in which, as shown in FIG. 1B, the first magnetic metal phase is formed from a plurality of magnetic metal particles 10, and the second phase is a coating layer 22 that covers the magnetic metal particles, may also be adopted. In regard to the configuration of FIG. 1A, since the preparation may be easily achieved, a low-cost process is likely to be realized, and during the operation of synthesizing nanoparticle aggregates by processing, the magnetic metal phase may be highly slippery, while low coercivity and high magnetic permeability may be easily realized, which is preferable. Furthermore, in the configuration of core-shell type magnetic particles of FIG. 1B, since the first magnetic metal phase and the second phase form an interface by adopting a core/shell structure, formation of nanoparticle aggregates including magnetic metal nanoparticles and the second phase (compositization) may proceed easily, and low coercivity and high magnetic permeability as well as characteristics such as high strength, high toughness, high stability over time, high thermal stability and high oxidation resistance may be obtained easily, which is preferable.

Here, the invention will be further explained below by taking the case of preparing core-shell type magnetic particles as an example. Meanwhile, core-shell type magnetic particles are particles in which the part corresponding to the first magnetic metal phase constitutes the core, and the part corresponding to the second phase constitutes the shell (coating layer). In this case, even if not all the particles take such a core/shell structure, it does not matter as long as the second phase corresponding to the shell is disposed in any form or structure between the individual first magnetic metal phases corresponding to the core. In the following, an example of core-shell type magnetic particles will be described.

When the core-shell type magnetic particles are prepared, the production method for the particles is not particularly limited. For example, the core-shell type magnetic particles can be produced by first synthesizing magnetic metal particles, and then forming a coating layer by a coating treatment. Here, the magnetic metal particles are synthesized by, for example, a water atomization method, a gas atomization method, a heat plasma method, a chemical vapor deposition (CVD) method, a laser ablation method, an in-liquid dispersion method, or a liquid phase synthesis method (a polyol method, a thermal decomposition method, a reverse micelle method, a co-precipitation method, a mechanochemical method, a mechanofusion method, or the like). Furthermore, the core-shell magnetic particles may also be synthesized by a method of reducing oxide fine particles synthesized by a co-precipitation method or the like. Since this method can synthesize magnetic metal particles in large quantities by a convenient and inexpensive technique, the method is preferable in the case of considering a mass production process. A heat plasma method enables the synthesis of large quantities to be carried out easily, which is preferable. In the case of using a heat plasma method, first, raw materials including a magnetic metal powder having an average particle size of several micrometers (μm) and a non-magnetic metal are injected together with a carrier gas into a plasma generated in the chamber of a high frequency induction heat plasma apparatus. Thereby, magnetic metal particles containing a magnetic metal can be easily synthesized. A liquid phase synthesis method is carried out such that a coating treatment is performed continuously in a liquid phase, and this method is preferable from the viewpoints of low cost and high product yield.

Next, the means for forming a coating layer on at least a portion of the surface of the magnetic metal particles is also not particularly limited, and examples include a liquid phase coating method, a partial oxidation method, and a gas phase method such as vapor deposition or sputtering.

Examples of the liquid phase coating method include a sol-gel method, a dip coating method, a spin coating method, a co-precipitation method, and a plating method. These methods can conveniently form a compact and uniform coating layer at a low temperature, and therefore, it is preferable. Among them, particularly the sol-gel method is preferred from the viewpoint that a compact film can be produced conveniently. Furthermore, when an appropriate heat treatment is applied at the time of forming a coating layer, a coating is formed compactly and uniformly, and therefore, it is preferable. The heat treatment is preferably carried out at a temperature of from 50° C. to 800° C., and more preferably from 300° C. to 500° C. The atmosphere is preferably a vacuum atmosphere or a reducing atmosphere of H₂, CO, CH₄ or the like. This is because the magnetic particles can be prevented from being oxidized and deteriorated during heating molding.

The partial oxidation method is a method of synthesizing magnetic metal particles containing a magnetic metal and a non-magnetic metal, subsequently performing a partial oxidation treatment under appropriate oxidizing conditions, and thereby precipitating an oxide containing the non-magnetic metal on the surface of the magnetic metal particles, as a coating layer. Furthermore, when this partial oxidation method is applied to the formation of a coating layer of a nitride, a carbide or a fluoride, a partial nitridation treatment, a partial carbonization treatment or a partial fluorination treatment may be carried out instead of a partial oxidation treatment.

This technique causes precipitation of oxides through diffusion, and when compared with a liquid phase coating method, this technique is preferred because the interface between the magnetic metal particles and the oxide coating layer firmly adheres to the magnetic metal particles and the oxide coating layer, and thermal stability and oxidation resistance of the magnetic metal particles are increased, which is preferable. The conditions for partial oxidation are not particularly limited; however, it is preferable that oxidation be carried out in an oxidizing atmosphere of O₂, CO₂ or the like by adjusting the oxygen concentration, at a temperature in the range of from room temperature to 1000° C.

Meanwhile, the step of coating may be carried out during the process for synthesizing the magnetic metal particles. That is, core-shell type magnetic metal particles containing an oxide coating layer containing a non-magnetic metal on the surface of magnetic metal particles may also be synthesized by controlling the process conditions in the middle of synthesizing the magnetic metal particles with heat plasma.

Furthermore, it is more preferable that the coating layer be formed of an oxide, a composite oxide, a nitride, a carbide or a fluoride containing at least one non-magnetic metal selected from the group consisting of Mg, Al, Si, Ca, Zr, Ti, Hf, Zn, Mn, Ba, Sr, Cr, Mo, Ag, Ga, Sc, V, Y, Nb, Pb, Cu, In, Sn and rare earth elements. When the magnetic metal particles containing at least one non-magnetic metal selected from the group consisting of Mg, Al, Si, Ca, Zr, Ti, Hf, Zn, Mn, Ba, Sr, Cr, Mo, Ag, Ga, Sc, V, Y, Nb, Pb, Cu, In, Sn and rare earth elements, it is more preferable that the coating layer include an oxide, a composite oxide, a nitride, a carbide or a fluoride containing at least one of non-magnetic metals that are the same as the non-magnetic metals, which constitute one constituent component of the magnetic metal particles. Thereby, the adhesiveness between the magnetic metal particles and the coating layer can be increased, and the thermal stability and oxidation resistance of the magnetic material can be enhanced.

Meanwhile, in regard to the above-described coating layer configuration, among an oxide, a composite oxide, a nitride, a carbide and a fluoride, particularly an oxide and a composite oxide are more preferred. This is due to the viewpoints of the ease of the formation of a coating layer, oxidation resistance, and thermal stability.

Furthermore, it is preferable that an oxide or composite oxide coating layer include an oxide or a composite oxide containing at least one magnetic metal, which is a constituent component of the magnetic metal particles, and include an oxide or a composite oxide containing at least one non-magnetic metal selected from the group consisting of Mg, Al, Si, Ca, Zr, Ti, Hf, Zn, Mn, Ba, Sr, Cr, Mo, Ag, Ga, Sc, V, Y, Nb, Pb, Cu, In, Sn and rare earth elements.

This non-magnetic metal is an element which has low standard Gibbs energy of formation of an oxide, and can easily form astable oxide. An oxide coating layer formed of an oxide or a composite oxide containing at least one or more of such non-magnetic metals, can enhance the adhesiveness and bondability to the magnetic metal particles, and the thermal stability and oxidation resistance of the magnetic metal particles can also be enhanced.

Among the non-magnetic metals, Al and Si are preferable because these elements can easily form solid solutions with Fe, Co and Ni, which are main components of the magnetic metal particles, and contribute to an enhancement of thermal stability of the magnetic metal particles. Composite oxides containing plural kinds of non-magnetic metals also include the form of solid solutions. The coating layer that covers at least a portion of the surface of the magnetic metal particles can enhance the oxidation resistance of the internal magnetic metal particles, and also can enhance the electrical resistance of the particle aggregates obtained after the subsequent processing. When the electrical resistance is increased, an eddy current loss at a high frequency can be suppressed, and thus the high frequency characteristics of the magnetic permeability can be enhanced. For this reason, it is preferable that the coating layer has high electrical resistance, and for example, it is preferable that the coating layer have a resistance value of 1 mΩ·cm or more.

As the coating layer is thicker, the electrical resistance of the particle aggregates is increased, and the thermal stability and oxidation resistance of the magnetic metal particles are also increased. However, if the coating layer is made too thick, since the saturation magnetization is lowered, the magnetic permeability also becomes lower, which is not preferable. In order to make the saturation magnetization higher while maintaining the electrical resistance to be large to a certain extent, it is more preferable that the coating layer have an average thickness of from 0.1 nm to 5 nm.

According to the present embodiment, the method for preparing a mixed phase material is not particularly limited; however, for example, a process characterized by preparing the mixed phase material by a process of flattening and compositizing the core-shell type magnetic particles through the processing of applying a gravitational acceleration of from 40 G to 1000 G, is preferred. Thereby, an aggregated structure in which the magnetic metal phase and the second phase are dispersed in a relatively strongly bound state, can be obtained. Meanwhile, the mixed phase material may also be prepared by a process of flattening and compositizing a raw material powder of the first magnetic metal and a raw material powder of the second phase, instead of the core-shell type magnetic particles, through the processing of applying a gravitational acceleration of from 40 G to 1000 G. Thereby, an aggregated structure in which the magnetic metal phase and the second phase are dispersed in a strongly bound state may be obtained, and this is preferable from the viewpoints of high strength and high toughness. If the gravitational acceleration is smaller than this range, the mixed phase material is not formed satisfactorily. Also, if the gravitational acceleration is larger than this range, since the acceleration is too high, strain occurs in the mixed phase material to a large extent, which is not preferable.

Furthermore, in the present step, the mixed phase material may also be prepared by, for example, a process of compositizing the core-shell type magnetic particles through the processing of applying a gravitational acceleration of more than or equal to 10 G but less than 40 G. Thereby, an aggregated structure in which the magnetic metal phase and the second phase are dispersed in a relatively weakly bound state, can be obtained, and this is preferable from the viewpoint of low crystal strain. Meanwhile, it is also acceptable to use a raw material powder of the first magnetic metal phase and a raw material powder of the second phase, instead of the core-shell type magnetic particles. If the gravitational acceleration is smaller than this range, the mixed phase material is not formed satisfactorily. Also, if the gravitational acceleration is larger than this range, since the acceleration is too high, strain occurs in the mixed phase material to a large extent, which is not preferable.

Furthermore, in the present step, the mixed phase material may also be prepared by, for example, a process of compositizing an alloy ribbon formed from the first magnetic metal phase and the non-magnetic metal, through the processing of applying a gravitational acceleration of from 10 G to 1000 G. Thereby, during the processing, particularly the non-magnetic metal is oxidized, nitrided or carbonized to form particles formed from a second phase, and finally, an aggregated structure of the first magnetic metal phase and particles of the second phase can be obtained. If the gravitational acceleration is smaller than this range, the mixed phase material is not formed satisfactorily. Also, if the gravitational acceleration is larger than this range, since the acceleration is too high, strain occurs in the mixed phase material to a large extent, which is not preferable.

The method for synthesizing the mixed phase material will be described in detail below. The present processing treatment step is not particularly limited; however, for example, a composite integration treatment can be carried out relatively easily using a high power mill apparatus. Alternatively, the processing treatment can also be carried out by a treatment of performing pulverization (or dissolution and evaporation) while reaggregating the resultant by an electrochemical method such as an electrophoresis method or an electrodeposition method, or the like. Alternatively, the processing treatment can also be carried out by a mechanofusion method, an aerosol deposition method, a supersonic free jet physical vapor deposition (PVD) method, a supersonic flame thermal spray method, an ultrasonic spray coating method, a spray method or the like, or a method equivalent thereto.

Regarding the high power mill apparatus, an apparatus capable of applying a strong gravitational acceleration is preferred; however, the kind of the apparatus is not particularly selected (examples include a planetary mill, a bead mill, a rotary ball mill, a vibratory ball mill, an agitating ball mill (attriter), a jet mill, a centrifuge, and techniques combining milling and centrifugation), and for example, a High Power Planetary Mill apparatus and the like that are capable of applying a gravitational acceleration of several ten G are preferred. In the case of a High Power Planetary Mill apparatus, a tilted type planetary mill apparatus in which the direction of rotational gravitational acceleration and the direction of revolutionary gravitational acceleration are not directions on the same straight line but are directions forming an angle, is more preferred. In conventional planetary mill apparatuses, the direction of rotational gravitational acceleration and the direction of revolutionary gravitational acceleration are directions on the same straight line; however, in a tilted type planetary mill apparatus, since the vessel performs a rotating movement in a tilted state, the direction of rotational gravitational acceleration and the direction of revolutionary gravitational acceleration are not on the same straight line but form an angle. Thereby, power is efficiently transferred to a sample, and compositization and flattening proceed with high efficiency, which is preferable. Furthermore, regarding the gravitational acceleration, if possible, it is preferable to apply a gravitational acceleration of from 40 G to 1000 G, and more preferably from 100 G to 1000 G.

Furthermore, in consideration of mass production, a bead mill apparatus that can facilitate treatment of large quantities is preferred. That is, in the case of a process considering mass productivity, it is desirable that first, magnetic metal particles be synthesized by a liquid phase synthesis method such as a polyol method, a thermal decomposition method, a reverse micelle method, a co-precipitation method, a mechanochemical method, or a mechanofusion method, subsequently an interstitial phase (coating layer) of an oxide be formed on at least a portion of the surface of the magnetic metal particles by a liquid phase coating method such as a sol-gel method, a dip coating method, a spin coating method, a co-precipitation method, or a plating method, and then the magnetic metal particles and the interstitial phase be integrated using a bead mill apparatus. This combination is preferable because since the various processes are commonized to be liquid phase processes, a continuous treatment is facilitated, a large amount can be subjected to treatment all at once, and the production cost can be decreased, which is preferable. Furthermore, since liquid phase processes can synthesize homogeneous materials having refined structures liquid phase processes can realize excellent magnetic characteristics (high magnetic permeability, low loss, high saturation magnetization, and the like). Thus, liquid phase processes are preferable.

In regard to the composite integration treatment using a high power mill apparatus, it is preferable that the magnetic metal particles containing the interstitial phase be processed with a wet type mill together with balls having a diameter of from 0.1 mm to 10 mm and a solvent. The solvent is preferably a solvent in which particles can be dispersed therein, and a ketone-based solvent, particularly acetone, is preferred. Furthermore, the diameter of the ball is preferably from 0.1 mm to 5 mm, and more preferably from 0.1 mm to 2 mm. If the diameter of the ball is too small, recovery of a powder is made difficult, and yield does not increase, which is not preferable. On the other hand, if the diameter of the ball is too large, the probability at which the powder is brought into contact is decreased, and compositization and flattening are not likely to proceed, which is not preferable. If efficiency is to be considered, the ball diameter is preferably from 0.1 mm to 5 mm, and more preferably from 0.1 mm to 2 mm. Also, the weight ratio of the balls with respect to the sample powder may vary depending on the ball diameter, but the weight ratio is more preferably from 10 to 80. In regard to the composite integration treatment using a high power mill apparatus, strain may occur in the material depending on the conditions, and this leads to an increase in the coercivity (when the coercivity increases, the hysteresis loss is increased, and the magnetic losses are increased), which is not preferable. It is preferable to select conditions in which the composite integration treatment can be efficiently carried out without applying any unnecessary strain to the material.

Furthermore, when a high power mill apparatus is used, it is preferable to perform the operation in an inert gas atmosphere in order to suppress oxidation of the magnetic nanoparticles as far as possible. Also, when the composite integration treatment of a powder is carried out under dry conditions, the composite integration treatment may proceed easily; however, the structure is prone to be coarsened, and collection of the particles becomes difficult. Also, the shape of the particles thus obtainable becomes spherical in many cases.

On the other hand, when the composite integration treatment is carried out under wet conditions using a liquid solvent, it is preferable because coarsening of the structure is suppressed, and the shape can be easily flattened. It is more preferable to perform a treatment for suppressing coarsening of the structure while promoting composite integration, by performing both the dry treatment and the wet treatment.

Particle aggregates can be easily synthesized by using such techniques, and depending on the synthesis conditions, making the shape of the particle aggregates into a flat shape with a large aspect ratio can also be easily realized, which is preferable. By producing composite particles having a large aspect ratio, shape-induced magnetic anisotropy can be imparted, and when the directions of the axes of easy magnetization are aligned in a single direction, the magnetic permeability and the high frequency characteristics of the magnetic permeability can be enhanced, which is preferable.

Meanwhile, in regard to the present composite integration treatment step, it is also possible to carry out the composite integration treatment while forming an oxide, by controlling the treatment conditions, specifically by controlling the oxygen partial pressure of the atmosphere or the kind of the liquid solvent at the time of wet mixing. As such, the process of forming an oxide may be carried out during the step of synthesizing the magnetic metal particles, or may be carried out during the composite integration treatment step, in addition to the option of performing the process after the magnetic metal particles are synthesized.

Next, the second step of conducting a heat treatment to the particle aggregates (mixed phase material) at a temperature of from 50° C. to 800° C., or conducting a first heat treatment to the mixed phase material at a temperature of from 50° C. to 800° C., is explained. The present process is a process effective for releasing the strain generated when the particle aggregates are synthesized. The temperature is preferably from 50° C. to 800° C., and a temperature of from 300° C. to 500° C. is more preferred. When the temperature is set to this temperature range, the strain applied to the particle aggregates can be effectively released and relieved. Thereby, the coercivity that has been increased by strain can be decreased, and the hysteresis loss can be decreased (magnetic losses can be decreased). Also, since the coercivity can be decreased, the magnetic permeability can be enhanced. Meanwhile, the heat treatment of the present process is preferably carried out in an atmosphere of a low oxygen concentration or in a vacuum atmosphere; however, more preferably, a reducing atmosphere of H₂, CO, CH₄ or the like is preferred. Then, even if the particle aggregates are oxidized, the oxidized metal can be reduced and returned to metal by subjecting the particle aggregates to a heat treatment in a reducing atmosphere. Through this, the particle aggregates that have been oxidized and have the saturation magnetization decreased can be reduced, and thereby the saturation magnetization can be recovered (magnetic permeability can also be enhanced). Meanwhile, for the heat treatment, it is preferable to select conditions in which aggregation or necking of the magnetic particles is suppressed as far as possible.

Next, the third step of obtaining nanoparticle aggregates formed from (including) magnetic metal nanoparticles as the first magnetic metal phase and the second phase, by decreasing the average particle size and the particle size distribution variation of the first magnetic metal phase in the mixed phase material obtained after heat-treating the mixed phase material, will be explained. Namely, forming nanoparticle aggregates including a plurality of magnetic metal nanoparticles formed from the first magnetic metal phase and the second phase, the nanoparticle aggregates being formed by decreasing an average particle size and a particle size distribution variation of the first magnetic metal phase after the first heat treatment, will be explained. Here, the nanoparticle aggregates being formed by decreasing an average particle size and a particle size distribution variation of the magnetic metal phase the first heat treatment. In the present step, an aggregated structure in which the average particle size and the particle size distribution variation of the magnetic metal phase are large, are formed in a state in which the magnetic metal phase has high strain (crystal strain or the like) after the second step, and therefore, the magnetic characteristics are also insufficient. That is, in this state, the coercivity is not yet sufficiently decreased, and accordingly the hysteresis loss becomes relatively larger, while the magnetic permeability becomes relatively smaller. Thus, when a uniformly dispersed structure with less aggregation, and a structure having a decreased average particle size and a decreased particle size distribution variation are obtained by dividing and rearranging the magnetic metal phase through the present step, excellent magnetic characteristics, excellent thermal stability, high oxidation resistance, high strength and high toughness can be realized. That is, the coercivity is decreased, and accordingly the hysteresis loss is decreased, while the magnetic permeability is enhanced. Furthermore, since a structure in which individual magnetic metal nanoparticles are surrounded by a second phase may be easily formed by dividing and rearranging the magnetic metal phase, the thermal stability and oxidation resistance of the magnetic metal particles are dramatically enhanced. Furthermore, high strength and high toughness can be obtained by the dispersed structure of the magnetic metal phase and the second phase, which is preferable. Particularly, in regard to a composite structure of particle aggregates in which two different phases (magnetic metal phase and interstitial phase) are highly dispersed, when compared with the case of having a simple single phase, or with the case of a structure having two phases in a state of poor dispersibility, high strength and high toughness may be easily realized by a pinning effect or the like, which is preferable.

In the third step, for example, a composite integration treatment such as that used in the first step, that is, a treatment of applying a gravitational acceleration to the mixed phase material obtained after a heat treatment, such as that used in the first step, may also be used. For example, the treatment may be carried out by the processing of applying a gravitational acceleration of from 40 G to 1000 G. Particularly, it is preferable to carry out the treatment by applying, in the third step, a gravitational acceleration higher than the gravitational acceleration applied in the first step. Thereby, division and rearrangement of the magnetic metal phase further proceed, and the average particle size and the particle size distribution variation of the magnetic metal phase are reduced, which is preferable. Furthermore, since a structure in which individual magnetic metal nanoparticles are surrounded by a second phase is easily formed, the thermal stability and the oxidation resistance of the magnetic metal particles are further enhanced. In addition, strength and toughness are further increased by a dispersed structure of the magnetic metal phase and the second phase.

Furthermore, it is particularly preferable to carry out the treatment by applying, in the third step, a gravitational acceleration smaller than the gravitational acceleration applied in the first step. Thereby, division and rearrangement of the magnetic metal phase proceed, and the average particle size and the particle size distribution variation of the magnetic metal phase are decreased, while low crystal strain is maintained, which is preferable. Furthermore, since a structure in which individual magnetic metal nanoparticles are surrounded by a second phase is easily formed, the thermal stability and the oxidation resistance of the magnetic metal particles are further enhanced. In addition, strength and toughness are further enhanced by a dispersed structure of the magnetic metal phase and the second phase.

The present processing treatment step is not particularly limited; however, for example, a high power mill apparatus may be used. Alternatively, the present processing treatment step can also be carried out by a treatment of reaggregating particles by an electrochemical method such as an electrophoresis method or an electrodeposition method, while pulverizing (or dissolving and evaporating) the particles. Alternatively, the treatment can also be carried out by a mechanofusion method, an aerosol deposition method, a supersonic free jet PVD method, a supersonic flame thermal spray method, an ultrasonic spray coating method, a spray method or the like, or a method equivalent thereto. Regarding the high power mill apparatus, an apparatus capable of applying a strong gravitational acceleration is preferred; however, the kind of the apparatus is not particularly selected (examples include a planetary mill, a bead mill, a rotary ball mill, a vibratory ball mill, an agitating ball mill (attriter), a jet mill, a centrifuge, and techniques combining milling and centrifugation), and for example, a high power planetary mill apparatus and the like that are capable of applying a gravitational acceleration of several ten G are preferred. In the case of a high power planetary mill apparatus, a tilted type planetary mill apparatus in which the direction of rotational gravitational acceleration and the direction of revolutionary gravitational acceleration are not directions on the same straight line but are directions forming an angle, is more preferred. In conventional planetary mill apparatuses, the direction of rotational gravitational acceleration and the direction of revolutionary gravitational acceleration are directions on the same straight line; however, in a tilted type planetary mill apparatus, since the vessel performs a rotating movement in a tilted state, the direction of rotational gravitational acceleration and the direction of revolutionary gravitational acceleration are not on the same straight line but form an angle. Thereby, power is efficiently transferred to a sample, and compositization and flattening proceed with high efficiency, which is preferable. Furthermore, regarding the details of the high power mill apparatus, any descriptions overlapping with the description given in connection with the first step will not be repeated.

Next, the fourth step of conducting a heat treatment the particle aggregates at a temperature of from 50° C. to 800° C., or conducting a second heat treatment to the nanoparticle aggregates at a temperature of from 50° C. to 800° C., is explained. The present step is the same as the second step, and is a step effective for releasing the strain generated when the nanoparticle aggregates are synthesized. The temperature is preferably from 50° C. to 800° C., and more preferably a temperature of from 300° C. to 500° C. When the temperature is set to this temperature range, the strain applied to the nanoparticle aggregates can be effectively released and relieved. Thereby, the coercivity that has been increased by strain can be decreased, and the hysteresis loss can be decreased (magnetic losses can be reduced). Also, since the coercivity can be decreased, the magnetic permeability can be enhanced. Meanwhile, it is preferable to carry out the heat treatment of the present step in an atmosphere of a low oxygen concentration or in a vacuum atmosphere; however, more preferably, a reducing atmosphere of H₂, CO, CH₄ or the like is preferred. This enables a metal that has been oxidized, to be reduced and returned to simple metal by applying the heat treatment in a reducing atmosphere, even if the nanoparticle aggregates have been oxidized. Thereby, the nanoparticle aggregates that have been oxidized and have decreased saturation magnetization, can be reduced, thereby the saturation magnetization can be recovered (magnetic permeability can also be enhanced). Meanwhile, for the heat treatment, it is preferable to select conditions in which aggregation and necking of the magnetic metal nanoparticles are suppressed as far as possible.

Meanwhile, it is preferable to further include the third step and the fourth step at least one or more times, after the fourth step. Namely, it is preferable to form nanoparticle aggregates from the nanoparticle aggregates after the second heat treatment, the nanoparticle aggregates being formed by decreasing the average particle size and the particle size distribution variation of the first magnetic metal phase after the second heat treatment; and conduct a third heat treatment to the nanoparticle aggregates at a temperature of from 50° C. to 800° C. Thereby, the magnetic characteristics can be enhanced by dividing and rearranging the first magnetic metal phase and forming a uniformly dispersed structure. That is, the coercivity is decreased, consequently the hysteresis loss is decreased, and the magnetic permeability is enhanced. Here, the order of carrying out the steps is not particularly limited; however, it is preferable to carryout the first step, the second step, the third step, and the fourth step in sequence, and to subsequently carry out the third step, followed by the fourth step. Meanwhile, the numbers of the third step and the fourth step that are carried out after the first step, the second step, the third step and the fourth step are carried out in sequence, are preferably from 1 time to 4 times for both the third step and the fourth step, from the viewpoint of efficiently forming a structure in which the first magnetic metal phase is uniformly dispersed.

Furthermore, it is preferable that the gravitational accelerations applied in the first step, the third step, the third step of the second round, and the subsequent third step be respectively increased gradually (stepwise). Thereby, division and rearrangement of the magnetic metal phase further proceed, and the average particle size and the particle size distribution variation of the magnetic metal phase are decreased, which is preferable. Furthermore, since a structure in which individual magnetic metal nanoparticles are surrounded by a second phase is easily formed, the thermal stability and oxidation resistance of the magnetic metal particles are further enhanced. In addition, strength and toughness are further enhanced by a dispersed structure of the magnetic metal phase and the second phase.

Furthermore, it is preferable that the gravitational accelerations applied in the first step, the third step, the third step of the second round, and the subsequent third step be respectively decreased gradually (stepwise). Thereby, division and rearrangement of the magnetic metal phase proceed while low crystal strain is maintained, and the average particle size and the particle size distribution variation of the magnetic metal phase are decreased, which is preferable. Also, since a structure in which individual magnetic metal nanoparticles are surrounded by a second phase is easily formed, the thermal stability and oxidation resistance of the magnetic metal particles are further enhanced. Furthermore, strength and toughness are further enhanced by a dispersed structure of the magnetic metal phase and the second phase.

When the above-described steps are carried out, the characteristic of the composite magnetic material can be enhanced to a large extent. That is, crystal strain is decreased, the coercivity is decreased, consequently the hysteresis loss is also decreased, and thus the magnetic permeability is enhanced. Furthermore, since a structure in which individual magnetic metal nanoparticles are surrounded by a second phase by rearrangement of the first magnetic metal phase, is easily formed, the thermal stability and oxidation resistance of the magnetic metal nanoparticles are dramatically enhanced. Furthermore, high strength and high toughness can be obtained by the dispersed structure of the first magnetic metal phase and the second phase, which is preferable. Particularly, in a composite structure in which two different phases (first magnetic metal phase and second phase) are highly dispersed, when compared with the case of having a simple single phase, or with the case of a structure having two phases in a state of poor dispersibility, high strength and high toughness can be realized by a pinning effect or the like, and this is preferable.

Meanwhile, the particle size distribution variation can be defined by the coefficient of variation value (CV value). That is, CV value (%)=[standard deviation (μm) of the particle size distribution/average particle size (μm)]×100. It can be said that as the CV value is smaller, a sharp particle size distribution having a small particle size distribution variation is obtained. When the CV value defined above is from 0.1% to 40%, low coercivity, low hysteresis loss, high magnetic permeability, high thermal stability, and high oxidation resistance can be realized, which is preferable. Also, since the variation is small, high yield can also be easily realized.

Furthermore, crystal strain can be calculated by analyzing the line widths of XRD in detail. That is, the contributions of spreading of line widths can be separated into the crystal grain size and the crystal strain by applying the Halder-Wagner plot, the Hall-Williamson plot. Thereby, the crystal strain can be calculated. When the crystal strain (crystal strain (root mean square)) obtained by the Halder-Wagner plot described below is from 0.001% to 0.3%, low coercivity, low hysteresis loss, high magnetic permeability, high thermal, stability, and high oxidation resistance are obtained, which is preferable. Here, the Halder-Wagner plot is represented by the following formula:

$$\frac{{β}^{2}}{{tan}^{2} θ} = \frac{K λ}{D} \frac{β}{tan θsin θ} + 16 {ɛ}^{2} , \\ ɛ = {ɛ}_{max} = \frac{\sqrt{2 π}}{2} \sqrt{\overline{{ɛ}^{2}}} \qquad [ Mathematical Formula 1 ]$$

(β: width of integration, K: constant, λ: wavelength,

D: crystal grain size,

$$\sqrt{\overline{{ɛ}^{2}}}$$

crystal strain (root mean square))

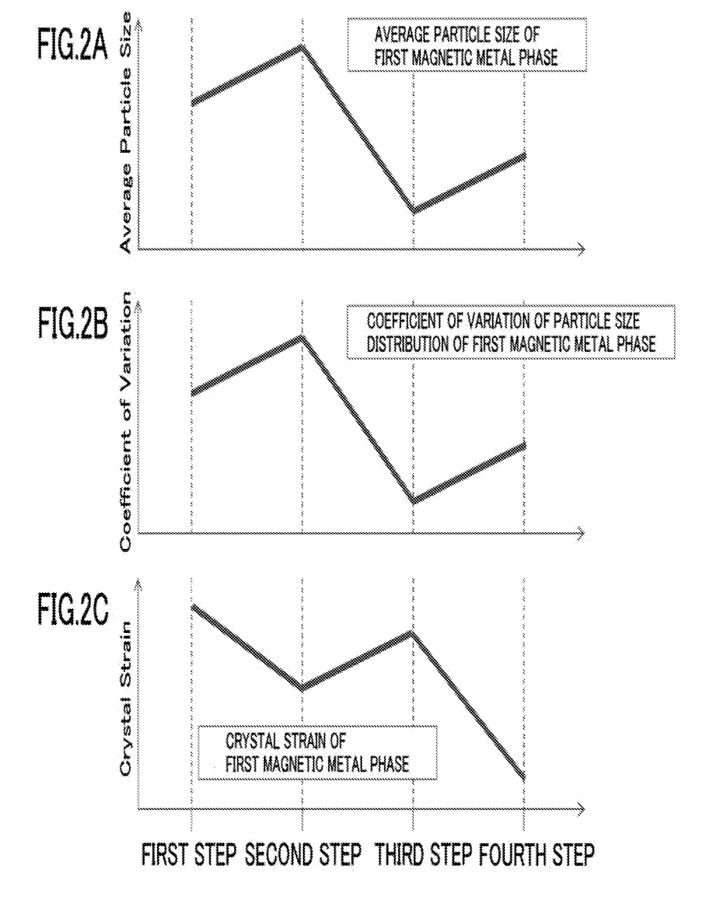

FIGS. 2A to 2C schematically illustrate, as an example, how the characteristics such as the average particle size, coefficient of variation of the particle size distribution, and crystal strain of the first magnetic metal phase, change respectively in the various steps of the first step, the second step, the third step, and the fourth step. That is, FIGS. 2A to 2C are schematic diagrams illustrating the characteristics change in the various steps of the present embodiment. The average particle size (FIG. 2A) and the coefficient of variation of the particle size distribution (FIG. 2B) are increased by the heat treatments performed in the first step and the second step; however, the average particle size and the coefficient of variation are largely decreased by the third step, and are slightly increased in the fourth step. On the other hand, the crystal strain (FIG. 2C) is decreased by the heat treatment performed in the first step and the second step; however, the crystal strain is slightly increased by the third step, and is decreased in the fourth step.

Next, the composition for the nanoparticle aggregate 200 (composite magnetic material) is explained.

The magnetic metal nanoparticles included in the nanoparticle aggregates contain at least one magnetic metal selected from the group consisting of Fe, Co and Ni. Furthermore, it is more preferable that the magnetic metal nanoparticles contain at least one non-magnetic metal selected from the group consisting of Mg, Al, Si, Ca, Zr, Ti, Hf, Zn, Mn, Ba, Sr, Cr, Mo, Ag, Ga, Sc, V, Y, Nb, Pb, Cu, In, Sn, and rare earth elements. These non-magnetic metals increase the resistance of the magnetic metal nanoparticles, and can enhance the thermal stability and oxidation resistance, which is preferable. Among them, Al and Si can easily form solid solutions with Fe, Co and Ni, which are main components of the magnetic metal nanoparticles, and contribute to an enhancement of the thermal stability of the magnetic metal nanoparticles, which is preferable.

The magnetic metal nanoparticles are formed from, for example, an alloy containing Fe, Co and Al, or an alloy containing Fe, Ni and Si.

The magnetic metals contained in the magnetic metal nanoparticles include at least one selected from the group consisting of Fe, Co and Ni, and particularly, a Fe-based alloy, a Co-based alloy, a FeCo-based alloy, and a FeNi-based alloy are preferred because these alloys can realize high saturation magnetization. A Fe-based alloy contains Ni, Mn, Cu and the like as a second component, and examples include a FeNi alloy, a FeMn alloy, and a FeCu alloy. A Co-based alloy contains Ni, Mn, Cu and the like as a second component, and examples include a CoNi alloy, a CoMn alloy, and a CoCu alloy. Examples of a FeCo-based alloy include alloys containing Ni, Mn, Cu and the like as the second component. These second components are components effective for enhancing the high frequency magnetic characteristics of the composite magnetic material that is finally obtained.

A FeNi-based alloy exhibits low magnetic anisotropy, and is therefore a material advantageous for obtaining high magnetic permeability. Particularly, a FeNi alloy having a Fe content of from 40 atom % to 60 atom % is preferable because the alloy exhibits high saturation magnetization and low anisotropy. A FeNi alloy having a Fe content of from 10 atom % to 40 atom %, and particularly from 10 atom % to 30 atom %, does not exhibit such high saturation magnetization; however, since the magnetic anisotropy becomes quite low, the FeNi alloy is preferable as a composition specialized for high magnetic permeability.

A FeCo-based alloy is preferable when it is intended to obtain high magnetic permeability, because the alloy has high saturation magnetization. The amount of Co in FeCo is preferably set to from 10 atom % to 50 atom %, from the viewpoint of having excellent thermal stability and high oxidation resistance and satisfying a saturation magnetization of 2 Tesla or higher. A more preferred amount of Co in FeCo is in the range of from 20 atom % to 40 atom % from the viewpoint of further increasing the saturation magnetization.

Regard to the amount of the non-magnetic metals contained in the magnetic metal nanoparticles, it is preferable that the non-magnetic metals be contained in an amount of from 0.001 atom % to 20 atom % relative to the amount of the magnetic metals. If the contents of the non-magnetic metals are respectively more than 20 atom %, there is a risk that saturation magnetization of the magnetic metal particles may be decreased. A more preferred amount from the viewpoints of high saturation magnetization and solid solubility is from 0.001 atom % to 10 atom %, more preferably from 0.01 atom % to 5 atom %, and more preferably, it is desirable that the non-magnetic metals be incorporated in an amount in the range of from 2 wt % to 5 wt %.

Regarding the crystal structure of the magnetic metal nanoparticles, a body-centered cubic lattice structure (bcc), a face-centered cubic lattice structure (fcc), and a hexagonal close-packed structure (hcp) may be considered, and each of them has unique features. The bcc structure is advantageous in that since a composition having a large proportion of a Fe-based alloy has the bcc structure, the crystal structure can be easily synthesized in a wide variety. The fcc structure is advantageous in that since the fcc structure can make the diffusion coefficient of a magnetic metal can be made smaller as compared with the bcc structure, thermal stability or oxidation resistance can be made relatively higher. Furthermore, in a case in which nanoparticle aggregates are synthesized by integrating the magnetic metal nanoparticles and the interstitial phase, integration or flattening may proceed easily as compared with the bcc structure or the like, and it is preferable. When integration or flattening proceeds easily, the nanoparticle aggregates may have a more refined structure, and a decrease of coercivity (led to a low hysteresis loss), an increase of resistance (led to a low eddy current loss), and an increase of magnetic permeability are promoted, which is preferable. The hcp structure (hexagonal structure) is advantageous in that the magnetic characteristics of a composite magnetic material can be made to exhibit in-plane uniaxial anisotropy. Since a magnetic metal having the hcp structure generally has high magnetic anisotropy, the magnetic metal can be easily oriented, and the magnetic permeability can be made higher. Particularly, a Co-based alloy is likely to have the hcp structure, and it is preferable. In the case of a Co-based alloy, the hcp structure can be stabilized by incorporating Cr or Al to the alloy, and it is preferable.

Meanwhile, in order to induce in-plane uniaxial anisotropy in a composite magnetic material (nanoparticle aggregates), there are available a method of orienting magnetic metal nanoparticles having the hcp structure, as well as a method of amorphizing crystallinity of the magnetic metal nanoparticles as far as possible, and inducing magnetic anisotropy in an in-plane direction by means of a magnetic field or strain. For this reason, it is preferable that the magnetic metal nanoparticles have a composition that can be easily amorphized as far as possible. From such a viewpoint, it is preferable that the magnetic metals contained in the magnetic metal nanoparticles contain at least one additive metal selected from boron (B), silicon (Si), carbon (C), titanium (Ti), zirconium (Zr), hafnium (Hf), niobium (Nb), tantalum (Ta), molybdenum (Mo), chromium (Cr), copper (Cu), tungsten (W), phosphorus (P), nitrogen (N), and gallium (Ga), which are different from the non-magnetic metals, in a total amount of from 0.001 atom % to 25 atom % relative to the total amount of the magnetic metals, the non-magnetic metals and the additive metals, and that at least two of the magnetic metals, the non-magnetic metals and the additive metals form a solid solution of each other.

Meanwhile, in regard to a magnetic material having in-plane uniaxial anisotropy, the anisotropic magnetic field in an easily magnetized plane is preferably from 1 Oe to 500 Oe, and more preferably from 10 Oe to 500 Oe. This is a preferred range for maintaining low loss and high magnetic permeability in the MHz range of 100 kHz or higher. If anisotropy is too low, the ferromagnetic resonance frequency occurs at a low frequency, and a large loss occurs in the MHz range, which is not preferable.

On the other hand, if anisotropy is high, the ferromagnetic resonance (FMR) frequency becomes high, and low loss can be realized; however, the magnetic permeability is also decreased, which is not preferable. The range of the anisotropic magnetic field that can achieve a balance between high magnetic permeability and low loss is preferably from 1 Oe to 500 Oe, and more preferably from 10 Oe to 500 Oe.

It is preferable for the magnetic metal nanoparticles, from the viewpoints of excellent thermal stability and high oxidation resistance, that oxygen be included in an amount of from 0.1 wt % to 20 wt %, preferably from 1 wt % to 10 wt %, and more preferably from 3 wt % to 7 wt %, relative to the total amount of the nanoparticle aggregates.

Furthermore, it is preferable that the magnetic metal nanoparticles contain carbon or nitrogen alone or in co-presence in an amount of from 0.001 atom % to 20 atom %, preferably from 0.001 atom % to 5 atom %, and more preferably from 0.01 atom % to 5 atom %, relative to the total amount of the nanoparticle aggregates. At least one of carbon and nitrogen can increase the magnetic anisotropy of the magnetic particles and increase the ferromagnetic resonance frequency by forming a solid solution with magnetic metals, and therefore, carbon and nitrogen can enhance the high frequency magnetic characteristics, which is preferable. If the content of at least one element selected from carbon and nitrogen is more than 20 atom %, solid solubility is decreased, and there is a risk that saturation magnetization of magnetic particles may be decreased. Regarding a more preferred amount from the viewpoints of high saturation magnetization and solid solubility, it is preferable that carbon or nitrogen be incorporated in an amount in the range of from 0.001 atom % to 5 atom %, and more preferably from 0.01 atom % to 5 atom %.

A preferred example of the composition of the magnetic metal nanoparticles is a product such as described below. For example, it is preferable that the magnetic metal particles contain Fe and Ni and contain at least one element selected from Al and Si; Fe be contained in an amount of from 40 atom % to 60 atom % relative to the total amount of Fe and Ni; at least one element selected from Al and Si be contained in an amount of from 0.001 wt % to 20 wt %, and more preferably from 2 wt % to 10 wt %, relative to the total amount of Fe and Ni; and oxygen be contained in an amount of from 0.1 wt % to 20 wt %, preferably from 1 wt % to 10 wt %, and more preferably from 3 wt % to 7 wt %, relative to the total amount of the nanoparticle aggregates. Also, more preferably, it is preferable that the magnetic metal nanoparticles contain carbon in an amount of from 0.001 atom % to 20 atom %, preferably from 0.001 atom % to 5 atom %, and more preferably from 0.01 atom % to 5 atom %, relative to the total amount of the nanoparticle aggregates. In regard to the above-described example, it is also preferable from the viewpoint of high saturation magnetization that Fe and Ni be substituted by Fe and Co, and the amount of Co be adjusted to the range of from 10 atom % to 50 atom %, and more preferably from 20 atom % to 40 atom %, relative to the total amount of Fe and Co.

As discussed above, when the configuration of the present embodiment is adopted, a composite magnetic material including magnetic metal nanoparticles, which are nanoparticle aggregates that contain magnetic metal nanoparticles having an average particle size of from 1 nm to 100 nm, preferably from 1 nm to 20 nm, and more preferably from 1 nm to 10 nm, and containing at least one magnetic metal selected from the group consisting of Fe, Co and Ni; and an interstitial phase existing between the magnetic metal nanoparticles and containing at least one non-magnetic metal selected from Mg, Al, Si, Ca, Zr, Ti, Hf, Zn, Mn, Ba, Sr, Cr, Mo, Ag, Ga, Sc, V, Y, Nb, Pb, Cu, In, Sn and rare earth elements, and any one of oxygen (O), nitrogen (N) or carbon (C), and have a shape having an average short dimension of from 10 nm to 2 μm, and preferably from 10 nm to 100 nm, and an average aspect ratio of from 5 to 1000, and preferably from 10 to 1000, and in which the volume packing ratio of the magnetic metal nanoparticles is from 40 vol % to 80 vol % relative to the entirety of the nanoparticle aggregates, can be produced with high product yield in a state of having high stability over time.

After the step of forming the nanoparticle aggregates, it is preferable to carry out the following step. That is, it is preferable to include a step of mixing the nanoparticle aggregates and a binder phase, and obtaining a mixed powder; a step of molding the mixed powder at a pressing pressure of 0.1 kgf/cm² or more; and a step of heat treating the resultant after molding at a temperature of from 50° C. to 800° C., and preferably from 300° C. to 500° C. More preferably, it is preferable to add a step of coating the surface of the nanoparticle aggregates with a coating layer, before the step of mixing the particle aggregates and a binder phase and obtaining a mixed powder.

In the case of coating the surface of the nanoparticle aggregates with a coating layer, the coating layer may be any of an organic system or an inorganic system; however, when thermal resistance is considered, an inorganic system is preferred. Examples of the organic system include a silane coupling agent, a silicone resin, a polysilazane, a polyvinyl butyral resin, a polyvinyl alcohol system, an epoxy system, a polybutadiene system, a TEFLON (registered trademark) system, a polystyrene-based resin, a polyester-based resin, a polyethylene-based resin, a polyvinyl chloride-based resin, a polyurethane resin, a cellulose-based resin, an ABS resin, a nitrile-butadiene-based rubber, a styrene-butadiene-based rubber, a phenolic resin, an amide-based resin, an imide-based resin, and copolymers thereof. Preferred examples of the inorganic system include oxides containing at least one non-magnetic metal selected from the group consisting of Mg, Al, Si, Ca, Zr, Ti, Hf, Zn, Mn, Ba, Sr, Cr, Mo, Ag, Ga, Sc, V, Y, Nb, Pb, Cu, In, Sn, and rare earth elements. Particularly preferred examples are oxides containing Al or Si. Other preferred examples of the oxides include eutectic oxides and glasses, and preferred examples include B₂O₃—SiO₂, B₂O₃—Cr₂O₃, B₂O₃—MoO₃, B₂O₃—Nb₂O₅, B₂O₃—Li₂O₃, B₂O₃—BaO, B₂O₃—ZnO, B₂O₃—La₂O₃, B₂O₃—P₂O₅, B₂O₃—Al₂O₃, B₂O₃—GeO₂, B₂O₃—WO₃, B₂O₃—Cs₂O, B₂O₃—K₂O, Na₂O—SiO₂, Na₂O—B₂O₃, Na₂O—P₂O₅, Na₂O—Nb₂O₅, Na₂O—WO₃, Na₂O—MoO₃, Na₂O—GeO₂, Na₂O—TiO₂, Na₂O—As₂O₅, Na₂O—TiO₂, Li₂O—MoO₃, Li₂O—SiO₂, Li₂O—GeO₂, Li₂O—WO₃, Li₂O—V₂O₅, Li₂O—GeO₂, K₂O—SiO₂, K₂O—P₂O₅, K₂O—TiO₂, K₂O—As₂O₅, K₂O—WO₃, K₂O—MoO₃, K₂O—V₂O₅, K₂O—Nb₂O₅, K₂O—GeO₂, K₂O—Ta₂O₅, Cs₂O—MoO₃, Cs₂O—V₂O₅, Cs₂O—Nb₂O₅, Cs₂O—SiO₂, CaO—P₂O₅, CaO—B₂O₃, CaO—V₂O₅, ZnO—V₂O₅, BaO—V₂O₅, BaO—WO₃, Cr₂O₃—V₂O₅, ZnO—B₂O₃, PbO—SiO₂, and MoO₃—WO₃. Among them, more preferred examples include B₂O₃—SiO₂, B₂O₃—Cr₂O₃, B₂O₃—MoO₃, B₂O₃—Nb₂O₅, B₂O₃—Li₂O₃, B₂O₃—BaO, B₂O₃—ZnO, B₂O₃—La₂O₃, B₂O₃—P₂O₅, B₂O₃—Al₂O₃, B₂O₃—GeO₂, B₂O₃—WO₃, Na₂O—SiO₂, Na₂O—B₂O₃, Na₂O—P₂O₅, Na₂O—Nb₂O₅, Na₂O—WO₃, Na₂O—MoO₃, Na₂O—GeO₂, Na₂O—TiO₂, Na₂O—As₂O₅, Na₂O— TiO₂Li₂O—MoO₃, Li₂O—SiO₂, Li₂O—GeO₂, Li₂O—WO₃, Li₂O—V₂O₅, Li₂O—GeO₂, CaO—P₂O₅, CaO—B₂O₃, CaO—V₂O₅, ZnO—V₂O₅, BaO—V₂O₅, BaO—WO₃, Cr₂O₃—V₂O₅, ZnO—B₂O₃, and MoO₃—WO₃. Such combinations of oxides are preferable because the oxides have relatively low eutectic points and can easily produce eutectics. Particularly, combinations each having a eutectic point of 1000° C. or lower are preferred. Furthermore, the combination of oxides may be a combination of two or more, and examples include Na₂O—CaO—SiO₂, K₂O— CaO— SiO₂, Na₂O—B₂O₃—SiO₂, K₂O—PbO—SiO₂, BaO—SiO₂—B₂O₃, PbO—B₂O₃—SiO₂, and Y₂O₃—Al₂O₃—SiO₂. Other examples include La—Si—O—N, Ca—Al—Si—O—N, Y—Al—Si—O—N, Na—Si—O—N, Na—La—Si—O—N, Mg—Al—Si—O—N, Si—O—N, and Li—K—Al—Si—O—N. When the surface of the nanoparticle aggregates is coated with a coating layer, it is preferable because the insulating properties of the nanoparticle aggregates are markedly enhanced.

The technique for forming a coating layer is not particularly limited as long as it is a method capable of uniformly and compactly covering the surface. In the case of an inorganic coating layer, for example, a sol-gel method, a dip coating method, a spin coating method, a co-precipitation method, and a plating method are preferred because a compact and uniform coating layer can be formed conveniently at a low temperature. Furthermore, regarding the heat treatment temperature at the time of forming a coating layer, it is preferable to carry out the heat treatment at the lowest temperature at which coating can be carried out compactly and uniformly, and if possible, it is desirable to carry out the heat treatment at a heat treatment temperature of 400° C. or lower.

In the step of mixing the nanoparticle aggregates and a binder phase and obtaining a mixed powder, the means is not subject to selection as long as a method capable of mixing uniformly is employed. Preferably, it is preferable that the direction of gravitational acceleration applied to the nanoparticle aggregates at the time of mixing, be approximately consistent with the direction of the gravitational acceleration applied to the nanoparticle aggregates at the time of synthesizing the nanoparticle aggregates by processing the nanoparticle aggregates with the high power mill apparatus. Furthermore, it is preferable to adjust the magnitude of the gravitational acceleration applied to the nanoparticle aggregates at the time of mixing, to be smaller than the magnitude of the gravitational acceleration applied to the nanoparticle aggregates when the nanoparticle aggregates are synthesized by processing the nanoparticle aggregates with the high power mill apparatus. Thereby, unnecessary strain being applied to the sample can be suppressed as far as possible. Also, unnecessary crushing of the sample can be suppressed, and therefore, it is preferable. From such a point of view, in the present step, mixing methods such as ball milling and stirrer agitation are preferred. The binder phase may be any of an organic system or an inorganic system, similarly to the case of the coating layer; however, when heat resistance is considered, an inorganic binder phase is preferred. Regarding both the organic systems and inorganic system, preferred material compositions are the same as the material compositions in the case of the coating layer, and thus, further description will not be repeated here. The combination of the coating layer and the binder phase is not particularly limited, and may be any of a combination of inorganic system-inorganic system, a combination of inorganic system-organic system, a combination of organic system-inorganic system, and a combination of organic system-organic system. However, from the viewpoint of heat resistance, a combination of an inorganic system-inorganic system is particularly preferred.

In the process of forming the mixed powder at a pressing pressure of 0.1 kgf/cm² or more, techniques such as a uniaxial press molding method, a hot press molding method, a cold isostatic pressing (CIP) (isotropic pressure molding) method, a hot isostatic pressing (HIP) (hot isotropic pressing) method, and a spark plasma sintering (SPS) method may be employed. It is necessary to select conditions for satisfying high density and high saturation magnetization while satisfying high resistance. A particularly preferred pressing pressure is from 1 kgf/cm² to 6 kgf/cm². Particularly, in the case of performing molding while heating, such as in the case of hot pressing, HIP or SPS, it is preferable to perform the molding in an atmosphere of a low oxygen concentration. A vacuum atmosphere or a reducing atmosphere of H₂, CO, CH₄ or the like is preferred. This is to suppress deterioration by oxidation of the magnetic particles during heated molding.

The step of performing a post-molding heat treatment at a temperature of from 50° C. to 800° C., and preferably 300° C. to 500° C., is a process preferable for releasing the strain applied to the particle aggregates at the time of the mixing step or at the time of the molding step. Thereby, the coercivity that has been increased by strain can be decreased, and thereby the hysteresis loss can be decreased (magnetic losses can be decreased). Furthermore, the heat treatment of the present step is preferably carried out in an atmosphere of a low oxygen concentration. A vacuum atmosphere or a reducing atmosphere of H₂, CO, CH₄ or the like is preferred. This is to suppress deterioration by oxidation of the magnetic particles during heated molding. Furthermore, the step of heat treatment after molding may be carried out simultaneously with the molding step. That is, the molding treatment may also be carried out while performing a heat treatment under the same conditions as the heat treatment conditions employed at the time of the post-molding heat treatment step.

Meanwhile, after each of the steps, it is preferable to control the process conditions of each step so as to prevent oxidation of the magnetic particles and a subsequent decrease of the saturation magnetization. Depending on the cases, after each step, the saturation magnetization may be recovered by reducing the magnetic particles that have been oxidized and have the saturation magnetization decreased. Regarding the reducing conditions, it is preferable to perform the heat treatment at a temperature in the range of 100° C. to 1000° C. in a reducing atmosphere of H₂, CO, CH₄ or the like. At this time, it is preferable to select conditions in which aggregation and necking of the magnetic particles are suppressed as far as possible.

Examples of the morphology of the composite magnetic material include the bulk form described above (a pellet shape, a ring shape, a rectangular shape, or the like), as well as a film form including sheet, and a powder form. The technique for producing a sheet is not particularly limited; however, for example, a sheet can be produced by mixing the synthesized mixed particles of magnetic particles and oxide particles, a resin and a solvent to obtain a slurry, and applying and drying the slurry. Furthermore, a mixture of the mixed particles and a resin may be molded by pressing into a sheet form or a pellet form. Also, the mixed particles may be dispersed in a solvent and deposited by a method such as electrophoresis. When sheets are produced, it is desirable that the mixed particles be oriented in one direction, that is, a direction in which the easy axes of the individual magnetic particles are aligned. It is preferable because the magnetic permeability and the high frequency characteristics of the magnetic permeability of the magnetic material sheet in which the magnetic particles are gathered, are enhanced thereby. Examples of the means for orienting the particles include application and drying in a magnetic field, but there are no particular limitations. The magnetic sheet may be produced so as to have a laminated structure. The magnetic sheet can be easily made thicker by adopting a laminated structure, and also, the high frequency magnetic characteristics can be enhanced by alternately laminating a magnetic sheet and a non-magnetic insulating layer. That is, when a laminated structure produced by forming a magnetic layer containing magnetic particles into a sheet form having a thickness of 100 μm or less, and alternately laminating this sheet-like magnetic layer with a non-magnetic insulating oxide layer having a thickness of 100 μm or less, is adopted, the high frequency magnetic characteristics are enhanced. That is, by adjusting the thickness of a single layer of the magnetic layer to 100 μm or less, when a high frequency magnetic field is applied in an in-plane direction, the influence of a diamagnetic field can be reduced. Thus, not only the magnetic permeability can be increased, but also the high frequency characteristics of the magnetic permeability are enhanced. The lamination method is not particularly limited; however, lamination can be achieved by overlapping plural sheets of magnetic sheets, and compressing by a pressing method or the like, or by heating and sintering the magnetic sheets.

The composite magnetic material produced by the present embodiment realizes high magnetic permeability, low coercivity, low losses, high saturation magnetization, high strength, and high toughness in the MHz range of 100 kHz or higher. Also, high product yield a state of having high stability over time, high thermal stability, and high oxidation resistance can also be realized.

### Second Embodiment

According to the present embodiment, the mixed phase material of the first step is a particle aggregate in which the first magnetic metal phase is in the form of magnetic metal particles. Here, description of those matters overlapping with the matters in the first embodiment will not be repeated.

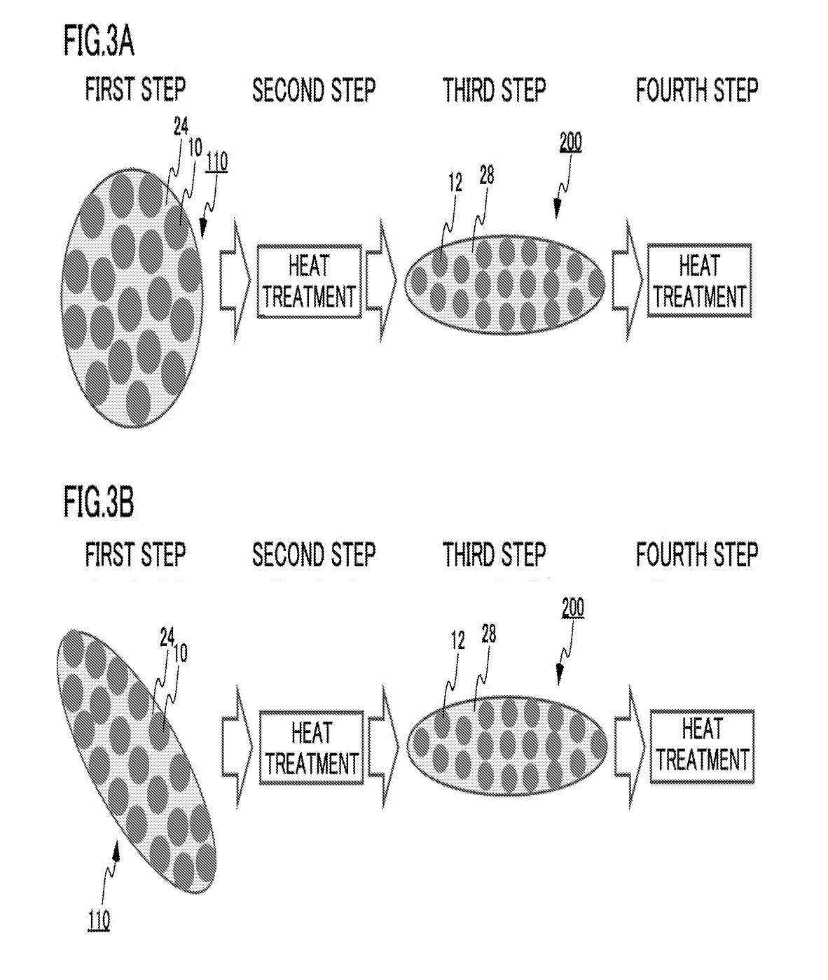

FIGS. 3A and 3B are schematic diagrams of the composite magnetic material of the present embodiment. According to the present embodiment, the mixed phase material 110 is formed from particle aggregates having a particulate shape, and a first magnetic metal phase is formed from a plurality of magnetic metal particles 10 disposed within the particle aggregates, while a second phase 24 is disposed around the magnetic metal particles within the particle aggregates. In FIG. 3A, the mixed phase material prepared in the first step is a spherical particle aggregate. Furthermore, in FIG. 3B, the mixed phase material prepared in the first step is a flat-shaped particle aggregate. Both are preferably used.

Further, it is preferable that the average particle size of the particle aggregates be from 10 nm to 10 μm; the average particle size of the magnetic metal particles of the first magnetic metal phase included in the particle aggregates be from 1 nm to 100 nm; the average short dimension of the nanoparticle aggregates be from 10 nm to 2 μm; the average aspect ratio be 5 or higher, and preferably from 10 to 1000; and the average particle size of the magnetic metal nanoparticles of the first magnetic metal phase included in the nanoparticle aggregates be from 1 nm to 20 nm.

Furthermore, it is preferable that the average short dimension of the particle aggregates be larger than the average short dimension of the composite magnetic material; the average aspect ratio of the particle aggregates be from more than or equal to 1 but less than 5 and be smaller than the average aspect ratio of the nanoparticle aggregates; and the average particle size of the magnetic metal particles of the first magnetic metal phase included in the particle aggregates be larger than the average particle size of the magnetic metal nanoparticles of the first magnetic metal phase included in the nanoparticle aggregates.

The composite magnetic material produced by the present embodiment realizes high magnetic permeability, low coercivity, low losses, high saturation magnetization, high strength, and high toughness in the MHz range of 100 kHz or higher. Furthermore, high product yield, a state of having high stability over time, high thermal stability, and high oxidation resistance can also be realized.

### Third Embodiment

According to the present embodiment, the mixed phase material of the first step is a particle aggregate in which the second phase is in the form of particles. Here, description of those matters overlapping with the matters in the first embodiment and the second embodiment will not be repeated.

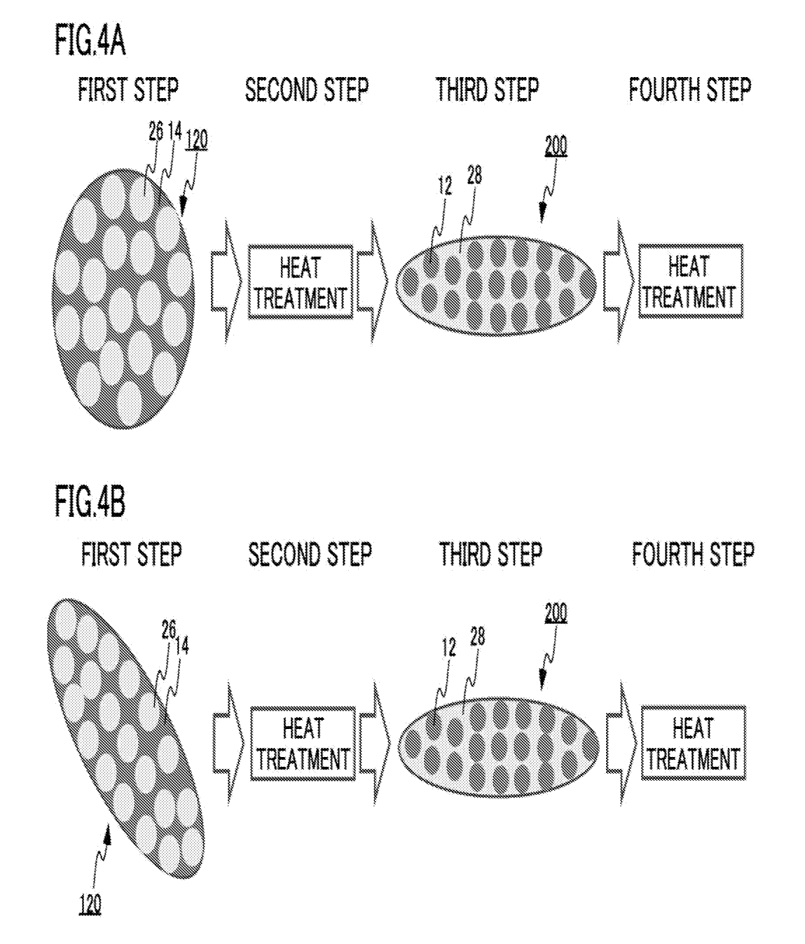

FIGS. 4A and 4B are schematic diagrams of the composite magnetic material of the present embodiment. According to the present embodiment, the mixed phase material is formed from particle aggregates having a particulate shape, and the first magnetic metal phase includes magnetic metal particles disposed within the particle aggregates, while the second phase is disposed around the magnetic metal particles within the particle aggregates. In FIG. 4A, the mixed phase material prepared in the first step is a spherical particle aggregate. Furthermore, in FIG. 4B, the mixed phase material prepared in the first step is a flat-shaped particle aggregate. Both are preferably used.

The composite magnetic material produced by the present embodiment realizes high magnetic permeability, low coercivity, low losses, high saturation magnetization, high strength, and high toughness in the MHz range of 100 kHz or higher. Furthermore, high product yield, a state of having high stability over time, high thermal stability, and high oxidation resistance can also be realized.

### Fourth Embodiment

The present embodiment relates to devices which use the composite materials produced by the first, second and third embodiments.

The composite magnetic materials produced by the first, second and third embodiments can be used in, for example, high frequency magnetic component parts such as inductors, choke coils, filters, and transformers; antenna substrates and component parts; and devices such as radio wave absorbers. The application in which the features of the magnetic materials of the embodiments described above can be best utilized is an inductor element for power inductors. Particularly, when the magnetic materials are applied to power inductors to which a high electric current is applied in the MHz range of 100 kHz or more, for example, in the 10 MHz range, the magnetic materials may easily exhibit the effect. Examples of preferred specifications for a magnetic material for power inductors include high magnetic permeability, low magnetic losses (primarily low eddy current loss and low hysteresis loss), and satisfactory direct current superposition characteristics. In power inductors having a frequency band lower than 100 kHz, existing materials such as a silicon steel sheet, a Sendust, an amorphous ribbon, a nanocrystalline ribbon, and a MnZn-based ferrite are used. However, a magnetic material which sufficiently satisfies the specifications required for power inductors in a frequency band of 100 kHz or higher is not available. For example, the metal-based materials described above cause large eddy current losses at a frequency of 100 kHz or higher, and therefore, use of the metal-based materials is not preferable. Also, MnZn ferrite or NiZn ferrite for dealing with high frequency bands have low saturation magnetization, and therefore, the direct current superposition characteristics are poor, which is not preferable. That is, a magnetic material which satisfies all of high magnetic permeability, low magnetic losses, and satisfactory direct current superposition characteristics in the MHz range of 100 kHz or higher, for example, in the 10 MHz range, has not been available, and there is a demand for the development of such a material.

From the same viewpoint, the composite magnetic material of the embodiment may be said to be a material which is excellent particularly in the characteristics of high magnetic permeability, low magnetic losses, and satisfactory direct current superposition characteristics. First, the eddy current loss can be decreased by high electrical resistance; however, particularly in the magnetic material described above, an oxide, a semiconductor, a carbide, a nitride, or a fluoride having high electrical resistance is included between magnetic particles or magnetic metal nanoparticles. For this reason, the electrical resistance can be increased, which is preferable.

Furthermore, the hysteresis loss can be decreased by lowering the coercivity (or magnetic anisotropy) of the magnetic material; however, in the composite magnetic materials of the embodiments, the magnetic anisotropy of individual magnetic particles is low. Moreover, as the individual magnetic metal particles magnetically interacted with neighboring particles, the total magnetic anisotropy can be further decreased. This effect can be realized since the particle size and the particle size distribution variation of the individual magnetic nanoparticles can be largely decreased by the present embodiments. Furthermore, this effect can also be enhanced by the fact that the crystal strain can be reduced. That is, in the magnetic materials described above, the eddy current loss as well as the hysteresis loss can be sufficiently decreased.

Furthermore, in order to realize satisfactory direct current superposition characteristics, it is critical to suppress magnetic saturation, and in order to do so, a material having high saturation magnetization is preferred. From that point of view, the magnetic materials of the embodiments described above are preferable because the total saturation magnetization can be made large by selecting magnetic metal particles having high saturation magnetization in the magnetic materials. Meanwhile, the magnetic permeability generally increases as the saturation magnetization increases, and as the magnetic anisotropy decreases. For this reason, the magnetic materials of the embodiments described above can also have enhanced magnetic permeability.

Furthermore, since the composite magnetic materials of the above-described embodiments are likely to have a structure in which individual magnetic metal nanoparticles are surrounded by a second phase (highly dispersed), the thermal stability and oxidation resistance of the magnetic metal particles are dramatically enhanced. Furthermore, high strength and high toughness can be obtained by a dispersed structure of a magnetic metal phase and a second phase, and it is preferable even from the viewpoint of obtaining excellent mechanical characteristics. Particularly, in regard to a composite structure in which two different phases (a magnetic metal phase and a second phase) are highly dispersed, when compared with the case of having a simple single phase, or with the case of a structure having two phases in a state of poor dispersibility, high strength and high toughness can be easily realized by a pinning effect or the like, which is preferable.

The method for producing a composite magnetic material of the above embodiment can provide a magnetic material having excellent magnetic characteristics and mechanical characteristics as described above, with high product yield.

From the above viewpoint, the composite magnetic material of the embodiment described above may particularly easily exhibit the effect, when the magnetic material is applied to an inductor element in a power inductor to which a high electric current is applied, particularly in the MHz range of 100 kHz or higher, for example, in the 10 MHz range.

Meanwhile, the magnetic material of the embodiment described above can be used not only in a high magnetic permeability component part such as an inductor element, but also as an electromagnetic wave absorber, by varying the frequency band of use. In general, a magnetic material takes high μ″ near a ferromagnetic resonance frequency; however, in the magnetic material of the above embodiment, various magnetic losses other than the ferromagnetic resonance loss, for example, the eddy current loss and the magnetic domain wall resonance loss can be suppressed as far as possible. Therefore, in a frequency band sufficiently lower than the ferromagnetic resonance frequency, μ″ can be decreased, while μ′ can be increased. That is, since a single material can be used as a high magnetic permeability component part as well as an electromagnetic wave absorber, by varying the frequency band of use, which is preferable.

On the other hand, since materials developed as electromagnetic wave absorbers are usually designed so as to maximize μ″ as far as possible by summing up all the losses composed of the ferromagnetic resonance loss and various magnetic losses (eddy current loss, magnetic domain wall resonance loss, and the like), it is not preferable to use a material that has been developed as an electromagnetic wave absorber, in high magnetic permeability component parts (high μ′ and low μ″) for inductor elements and antenna apparatuses, in any frequency band.

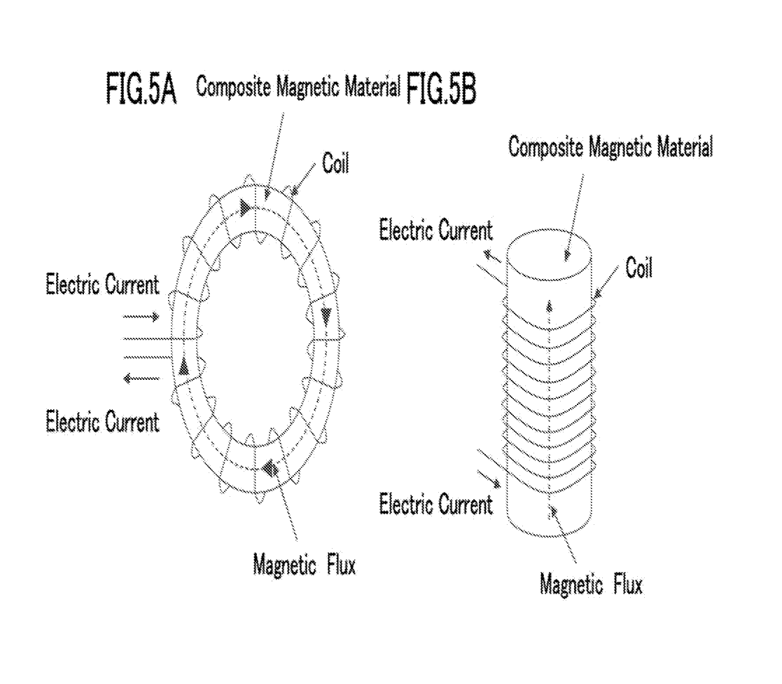

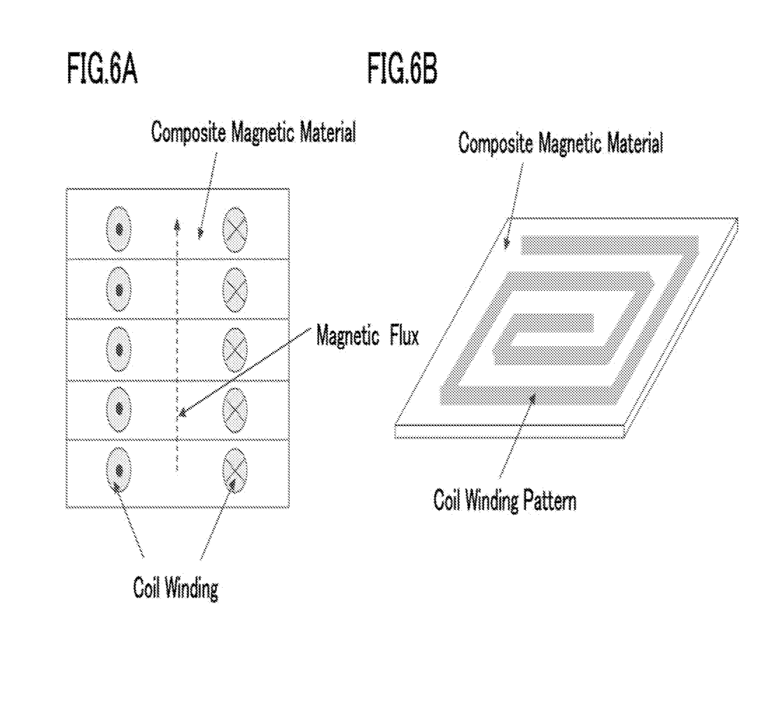

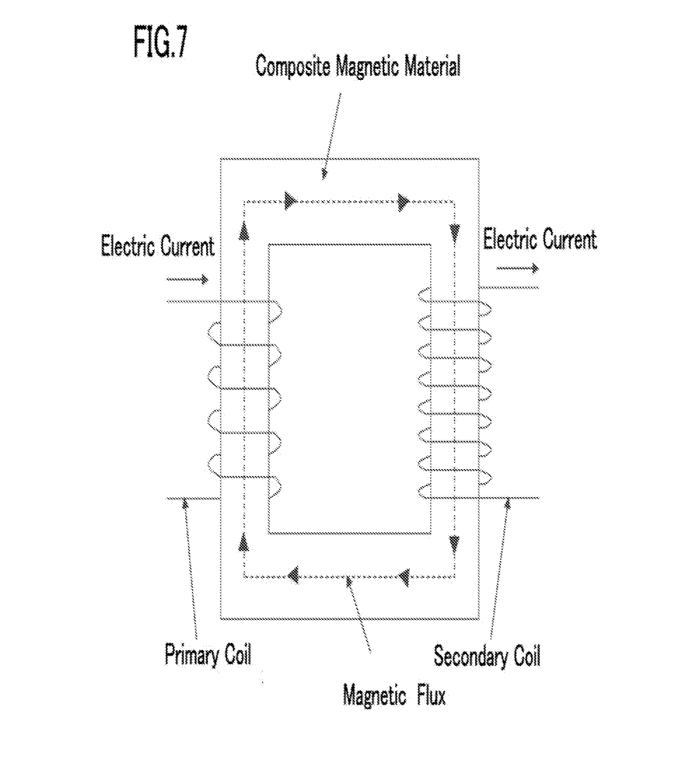

In order to apply a magnetic material to devices such as described above, the magnetic material can be subjected to various processing treatments. For example, in the case of a sintered product, mechanical processing such as polishing or cutting is applied, and in the case of a powder, mixing with a resin such as an epoxy resin or polybutadiene is applied. If necessary, a surface treatment is further applied. In a case in which the high frequency magnetic component part is an inductor, a choke coil, a filter or a transformer, a coiling treatment is achieved. Examples of the most fundamental structure include an inductor element in which a ring-shaped magnetic material is provided with a coil wound around the material, and an inductor element in which a rod shaped magnetic material is provided with a coil wound around the material. Furthermore, a chip inductor element in which a coil and a magnetic material are integrated, a planar inductor element, and the like can also be used. A laminate type inductor element may also be used. Further, an inductor element having a transformer structure may also be considered. In fact, these elements may have their structures and dimensions varied depending on the use and the required inductor element characteristics. FIGS. 5A and 5B and FIGS. 6A and 6B present schematic diagrams of representative inductance elements, and FIG. 7 presents a schematic diagram of a representative transformer structure.

According to the present embodiment, devices having excellent characteristics can be realized.

Thus, embodiments of the present invention have been explained with reference to specific examples. The embodiments described above are only for illustrative purposes, and are not intended to limit the present invention. Furthermore, the constituent elements of the various embodiments may also be appropriately combined.

In the descriptions of the embodiments, descriptions on the parts that are not directly related to the explanation of the present invention in connection with the composite magnetic material, the method for producing a composite magnetic material, an inductor element and the like, were not repeated. However, preferable elements related to the composite magnetic material, the method for producing a composite magnetic material, and the inductor element can be appropriately selected and used.

In addition, all composite magnetic materials, methods for producing a composite magnetic material, and inductor elements that include the elements of the present invention and can be appropriately designed and modified by those skilled in the art, are construed to be included in the scope of the present invention. The scope of the present invention is to be defined by the scope of the claims and equivalents thereof.

### EXAMPLES

Hereinafter, Examples 1 to 16 of the present invention will be described in more detail by making a comparison with Comparative Examples 1 to 8. In regard to the composite magnetic materials obtainable by Examples and Comparative Examples described below, the shape, average height, average aspect ratio and resistivity of the magnetic particles; the shape, composition, particle size, packing ratio, and average interparticle distance of the magnetic metal nanoparticles; and the composition of the interstitial phase are presented in Table 1. Meanwhile, the measurement of the average height of the magnetic particles is carried out by calculating the average value of particles based on a TEM observation or a scanning electron microscope (SEM) observation. Incidentally, the magnetic particles of the Examples are nanoparticle aggregates in which magnetic metal nanoparticles are dispersed at a high density, and the average particle size and the particle size distribution variation of the magnetic metal nanoparticles inside the magnetic particles are comprehensively determined based on a TEM observation and the crystal grain size obtained by XRD (using Scherrer's formula). Furthermore, a composition analysis of a microstructure is carried out based on an analysis by energy dispersive X-ray spectroscopy (EDX).

### Example 1

Argon as a gas for plasma generation is introduced into a chamber of a high frequency induction thermal plasma apparatus at a rate of 40 L/min, and plasma is generated. To this plasma in the chamber, raw materials including a Fe powder having an average particle size of 5 μm, a Ni powder having an average particle size of 3 μm, and a Si powder having an average particle size of 5 μm are sprayed together with argon (carrier gas) at a rate of 3 L/min. FeNiSi magnetic particles obtainable by rapidly cooling the powders are subjected to a partial oxidation treatment, and thereby core-shell type FeNiSi magnetic particles coated with Si—Fe—Ni—O are obtained. Subsequently, these core-shell type magnetic particles are subjected to a compositization treatment at a speed of rotation equivalent to a gravitational acceleration of about 60 G in an Ar atmosphere, and thus a mixed phase material is prepared (first step). Subsequently, these particle aggregates are subjected to a heat treatment in H₂ (hydrogen gas) at a temperature of 400° C. (second step). Subsequently, these particle aggregates are processed at a speed of rotation equivalent to a gravitational acceleration of about 60 G in an Ar atmosphere, and the average particle size and the particle size distribution variation of the FeNiSi phase (first magnetic metal phase) are decreased. Thereby, nanoparticle aggregates formed from magnetic metal nanoparticles of the FeNiSi phase and a second phase of Si—Fe—Ni—O are obtained (third step). Subsequently, a heat treatment in H₂ is carried out at a temperature of 400° C. (fourth step). The particles thus obtained were molded, and thereby a composite magnetic material for evaluation was produced.

### Example 2

A composite magnetic material was produced in the same manner as in Example 1, except that the Si powder used in Example 1 was changed to an Al powder having an average particle size of 3 μm.

### Example 3

A composite magnetic material was produced in the same manner as in Example 1, except that the Ni powder used in Example 1 was changed to a Co powder having an average particle size of 5 μm, and the Si powder was changed to an Al powder having an average particle size of 3 μm.

### Example 4

A composite magnetic material was produced in the same manner as in Example 1, except that the Ni powder used in Example 1 was changed to a Co powder having an average particle size of 5 μm.

### Example 5

A composite magnetic material was produced in the same manner as in Example 1, except that the compositization treatment in the first step of Example 1 was changed to a compositization treatment carried out at a speed of rotation equivalent to a gravitational acceleration of about 20 G in an Ar atmosphere.

### Example 6

A composite magnetic material was produced in the same manner as in Example 1, except that the procedure of Example 1 was changed such that the third step and the fourth step were repeated twice.

### Example 7

A composite magnetic material was produced in the same manner as in Example 1, except that the first step of Example 1 was changed to a process of synthesizing an alloy ribbon of Fe—Ni—Si using a roll rapid cooling apparatus, and then compositizing this alloy ribbon by processing equivalent to a gravitational acceleration of about 70 G.

### Example 8

A composite magnetic material was produced in the same manner as in Example 1, except that the first step of Example 1 was changed to a process of preparing the core-shell type magnetic particles thus obtainable as a mixed phase material.

### Comparative Example 1

A composite magnetic material was produced in the same manner as in Example 1, except that the third step and the fourth step were not carried out, as compared with Example 1. The magnetic material thus obtained has formed a structure in which spherical magnetic metal nanoparticles in the magnetic material are more aggregated (a structure with low dispersibility), compared with Example 1.

### Comparative Example 2

A composite magnetic material was produced in the same manner as in Example 2, except that the third step and the fourth step were not carried out as compared with Example 2. The magnetic material thus obtained has formed a structure in which spherical magnetic metal nanoparticles in the magnetic material are more aggregated (a structure with low dispersibility), compared with Example 2.

### Comparative Example 3

A composite magnetic material was produced in the same manner as in Example 3, except that the third step and the fourth step were not carried out as compared with Example 3. The magnetic material thus obtained has formed a structure in which spherical magnetic metal nanoparticles in the magnetic material are more aggregated (a structure with low dispersibility), compared with Example 3.

### Comparative Example 4

A composite magnetic material was produced in the same manner as in Example 4, except that the third step and the fourth step were not carried out as compared with Example 4. The magnetic material thus obtained has formed a structure in which spherical magnetic metal nanoparticles in the magnetic material are more aggregated (a structure with low dispersibility), compared with Example 4.

All of the composite magnetic materials obtainable in Examples 1 to 8 are nanoparticle aggregates in which spherical magnetic metal nanoparticles are packed in an oxide matrix (interstitial phase) at a high density. Meanwhile, when the crystal strain of the magnetic metal nanoparticles (corresponding to the first magnetic metal phase) in these nanoparticle aggregates is evaluated by applying the Halder-Wagner plot described above, it can be confirmed that the crystal strain is from 0.001% to 0.3% in all cases. Furthermore, the individual magnetic metal nanoparticles (corresponding to the first magnetic metal phase) in these composite magnetic materials form a uniformly dispersed structure with less aggregation, and regarding the particle size distribution, monodisperse particle size distributions are obtained, while sharp particle size distributions with less variation are obtained. The coefficients of variation, CV values, of the particle size distributions are from 0.1% to 40%, and sharp particle size distributions are realized.

On the other hand, in Comparative Examples 1 to 4, when the crystal strain of the magnetic metal nanoparticles (corresponding to the first magnetic metal phase) in the nanoparticle aggregates is evaluated by applying the Halder-Wagner plot described above, it can be confirmed that the crystal strain is larger than 0.3% in all cases. Furthermore, in the individual magnetic metal nanoparticles (corresponding to the first magnetic metal phase) in the nanoparticle aggregates, aggregated structures having poor dispersibility are observed, and regarding the particle size distribution, multimodal particle size distributions are obtained, or even in the case of monodisperse particle size distributions, particle size distribution broader than those of corresponding Examples are obtained (the coefficients of variation, CV values, of the particle size distributions are 50% or higher).

Next, with regard to the materials for evaluation of Examples 1 to 8 and Comparative Examples 1 to 4, the real part of magnetic permeability (μ′), the magnetic permeability loss (μ−tan δ=μ″/μ′×100(%)), the change over time in the real part of magnetic permeability (μ′) after 100 hours, the yield (%), and the strength ratio are evaluated by the following methods. The evaluation results are presented in Table 2.

1) Real Part of Magnetic Permeability, μ′, and Magnetic Permeability Loss (μ−tan δ=μ″/μ′×100(%)):

The magnetic permeability of a ring-shaped sample is measured using an impedance analyzer. The real part μ′ and the imaginary part μ″ at a frequency of 10 MHz are measured. Furthermore, the magnetic permeability loss, μ−tan δ, is calculated by the formula: μ″/μ′×100(%).

2) Change Over Time in Real Part of Magnetic Permeability, μ′, after 100 Hours

A sample for evaluation is heated at a temperature of 60° C. in air for 100 hours, and then the real part of magnetic permeability, μ′, is measured again. Thus, the change over time (real part of magnetic permeability, μ′, after standing for 100 H/real part of magnetic permeability, μ′, before standing) is determined.

3) Yield

One hundred samples for evaluation are produced, and the value of variance=(measured value−average value)/average value×100(%) is calculated for each of the real part of magnetic permeability, μ′, and the change ratio over time in the real part of magnetic permeability, μ′, after 100 hours. The number of samples for which the calculated value of variance is within the range of ±10% is measured, and yield is indicated as follows: yield (%)=(number of samples for which the calculated value of variance is within the range of ±10%/total number of samples for evaluation (100 samples))×100 (o).

4) Strength Ratio

The flexural strength of a sample for evaluation is measured, and the strength ratio is indicated as the ratio of the flexural strength to the flexural strength of a comparative sample (=flexural strength of sample for evaluation/flexural strength of comparative sample). Meanwhile, the ratio of Examples 1 is indicated as ratios with respect to Comparative Example 1; the ratio of Example 2 is indicated as the ratio with respect to Comparative Example 2; the ratio of Example 3 is indicated as the ratio with respect to Comparative Example 3; and the ratio of Example 4 is indicated as the ratio with respect to Comparative Example 4.

TABLE 1

| | Magnetic particles (particle aggregates) | | | | | | | | | | |
|---|---|---|---|---|---|---|---|---|---|---|---|
| | Constitution | | | | Magnetic metal nanoparticles | | | | | | |
| | | Average | Average | | | | Particle | CV | Packing | Average | Interstitial |
| | | height | aspect | Resistivity | | | size | value | ratio | interparticle | phase |
| | Shape | (μm) | ratio | (μΩ · cm) | Shape | Composition | (nm) | (%) | (vol %) | distance (nm) | Composition |
| Example 1 | Flat | 0.07 | 200 | 500 | Spherical | Fe—Ni—Si | 8 | 30 | 55 | 1 | Si—FeNi—O |
| | Shape | | | | shape | | | | | | |
| Example 2 | Flat | 0.07 | 180 | 500 | Spherical | Fe—Ni—Al | 8 | 33 | 54 | 1 | Al—FeNi—O |
| | Shape | | | | shape | | | | | | |
| Example 3 | Flat | 0.08 | 150 | 1000 | Spherical | Fe—Co—Al | 8 | 35 | 54 | 1 | Al—FeCo—O |
| | Shape | | | | shape | | | | | | |
| Example 4 | Flat | 0.08 | 170 | 1000 | Spherical | Fe—Co—Si | 8 | 33 | 55 | 1 | Si—FeCo—O |
| | Shape | | | | shape | | | | | | |
| Example 5 | Flat | 0.06 | 220 | 500 | Spherical | Fe—Ni—Si | 7 | 30 | 55 | 1 | Si—FeNi—O |
| | Shape | | | | shape | | | | | | |
| Example 6 | Flat | 0.06 | 250 | 600 | Spherical | Fe—Ni—Si | 7 | 28 | 55 | 1 | Si—FeNi—O |
| | Shape | | | | shape | | | | | | |
| Example 7 | Flat | 0.09 | 250 | 400 | Spherical | Fe—Ni—Si | 9 | 34 | 60 | 1 | Si—FeNi—O |
| | Shape | | | | shape | | | | | | |
| Example 8 | Flat | 0.09 | 100 | 300 | Spherical | Fe—Ni—Si | 9 | 38 | 55 | 1 | Si—FeNi—O |
| | Shape | | | | shape | | | | | | |
| Comparative | Flat | 0.12 | 130 | 80 | Spherical | Fe—Ni—Si | 15 | 50 | 55 | 1 | Si—FeNi—O |
| Example 1 | Shape | | | | shape | | | | | | |
| Comparative | Flat | 0.13 | 120 | 70 | Spherical | Fe—Ni—Al | 14 | 55 | 54 | 1 | Al—FeNi—O |
| Example 2 | Shape | | | | shape | | | | | | |
| Comparative | Flat | 0.11 | 100 | 80 | Spherical | Fe—Co—Al | 15 | 62 | 54 | 1 | Al—FeCo—O |
| Example 3 | Shape | | | | shape | | | | | | |
| Comparative | Flat | 0.12 | 110 | 90 | Spherical | Fe—Co—Si | 16 | 58 | 55 | 1 | Si—FeCo—O |
| Example 4 | Shape | | | | shape | | | | | | |

TABLE 2

| | Characteristics of high frequency magnetic material | | | | | |
|---|---|---|---|---|---|---|
| | Real part of | Magnetic | Change ratio over time in | | Yield of | |
| | magnetic | permeability | real part of magnetic | | change ratio | |
| | permeability, | loss, μ · tanδ | permeability, μ′ (10 MHz), | μ′ yield | over time | Strength |
| | μ′ (10 MHz) | (%) (10 MHz) | after 60° C. and 100 hr | (%) | (%) | ratio |
| Example 1 | 20 | <0.05 | 0.96 | 77 | 74 | 1.3 |
| Example 2 | 20 | <0.05 | 0.97 | 75 | 73 | 1.3 |
| Example 3 | 18 | <0.05 | 0.96 | 78 | 76 | 1.2 |
| Example 4 | 16 | <0.05 | 0.98 | 77 | 76 | 1.2 |
| Example 5 | 22 | <0.05 | 0.98 | 76 | 75 | — |
| Example 6 | 22 | <0.05 | 0.98 | 79 | 76 | — |
| Example 7 | 25 | <0.05 | 0.97 | 77 | 77 | — |
| Example 8 | 17 | <0.05 | 0.96 | 75 | 72 | — |
| Comparative | 11 | 0.05~0.1 | 0.92 | 35 | 38 | — |
| Example 1 | | | | | | |
| Comparative | 11 | 0.05~0.1 | 0.92 | 34 | 36 | — |
| Example 2 | | | | | | |
| Comparative | 9 | 0.05~0.1 | 0.93 | 31 | 32 | — |
| Example 3 | | | | | | |
| Comparative | 9 | 0.05~0.1 | 0.93 | 30 | 35 | — |
| Example 4 | | | | | | |

As is obvious from Table 1, in the composite magnetic materials related to Examples 1 to 8, flat-shaped particle aggregates in which magnetic metal nanoparticles having an average particle size of from 1 nm to 10 nm are packed at a packing ratio of from 40 vol % to 80 vol o, are used as magnetic particles. Furthermore, these magnetic particles have a shape with an average height of from 10 nm to 100 nm and an average aspect ratio of 10 or higher. The resistivity of the magnetic particles is from 100 μΩ·cm to 100 mΩ·cm. On the other hand, it can be seen that Comparative Examples 1 to 4 have average heights of the magnetic particles of larger than 100 nm, and have smaller aspect ratios, compared with Examples 1 to 4. This implies that Examples 1 to 4 are more likely to undergo flattening nanocompositization than Comparative Examples 1 to 4. It can be seen that Comparative Examples 1 to 4 have resistivities of smaller than 100 μΩ·cm. Furthermore, Comparative Examples 1 to 4 have average particle sizes of the magnetic metal nanoparticles of larger than 10 nm, and cannot realize finer structures than the Examples. Also, when the CV values are compared, it is understood that Examples 1 to 8 have CV values of from 0.1% to 40%, while Comparative Examples 1 to 4 have CV values of 50% or higher. These imply that in the materials of the Examples, the magnetic metal nanoparticles are dispersed with higher dispersibility within the finished nanoparticle aggregates, as compared with the Comparative Examples. Furthermore, it is understood also for Examples 5, 6, 7 and 8, structures and characteristics similar to those of Example 1 can be obtained. Furthermore, in Examples 1 to 8, the crystal strain of the magnetic metal nanoparticles (corresponding to the first magnetic metal phase) in the composite magnetic materials thus obtained is from 0.001% to 0.3% in all cases, and this is preferable from the viewpoints of low coercivity, low hysteresis loss, high magnetic permeability, high thermal stability, and high oxidation resistance.

Table 2 discloses the real part of magnetic permeability (μ′), the magnetic permeability loss (μ−tan δ=μ″/μ′×100(%)), the change over time in the real part of magnetic permeability (μ′) after 100 hours at 60° C., the μ′ yield (%), the yield of change over time (%), and the strength ratio. As can be clearly seen from Table 2, it is understood that the composite magnetic materials related to Examples 1 to 8 are excellent in all of the real part of magnetic permeability, the μ′ magnetic permeability loss, the change ratio over time, the W yield (%), the yield of change over time (%), and the strength ratio, as compared with the materials of Comparative Examples.

It is contemplated in regard to the materials of Examples 1 to 8 that when the first to fourth steps are carried out, flattening and compositization proceed efficiently, a more uniform and homogeneous structure having a smaller particle size (magnetic metal nanoparticles of the first magnetic metal phase) with less strain can be realized, and excellent magnetic characteristics (real part of magnetic permeability, magnetic permeability loss, change ratio over time, and yield) and excellent mechanical characteristics (strength and toughness) can be realized. Also, in regard to the saturation magnetization, all of the materials realized high saturation magnetization of 0.7 T or higher.

Thus, it is understood that the composite magnetic materials related to Examples 1 to 8 have high real parts of magnetic permeability (μ′) and low imaginary parts of magnetic permeability (μ″) in the MHz range of 100 kHz or higher, and have high saturation magnetization, high thermal stability, high oxidation resistance, high yield, and high strength.

### Example 9

A composite magnetic material was produced in the same manner as in Example 1, except that the heat treatment temperature in H₂ in the second step of Example 1 was changed to 50° C.

### Example 10

A composite magnetic material was produced in the same manner as in Example 1, except that the heat treatment temperature in H₂ in the second step of Example 1 was changed to 300° C.

### Example 11

A composite magnetic material was produced in the same manner as in Example 1, except that the heat treatment temperature in H₂ in the second step of Example 1 was changed to 500° C.

### Example 12

A composite magnetic material was produced in the same manner as in Example 1, except that the heat treatment temperature in H₂ in the second step of Example 1 was changed to 800° C.

### Comparative Example 5

A composite magnetic material was produced in the same manner as in Example 1, except that the heat treatment temperature in H₂ in the second step of Example 1 was changed to 30° C.

### Comparative Example 6

A composite magnetic material was produced in the same manner as in Example 1, except that the heat treatment temperature in H₂ in the second step of Example 1 was changed to 900° C.

### Example 13

A composite magnetic material was produced in the same manner as in Example 1, except that the heat treatment temperature in H₂ in the fourth step of Example 1 was changed to 50° C.

### Example 14

A composite magnetic material was produced in the same manner as in Example 1, except that the heat treatment temperature in H₂ in the fourth step of Example 1 was changed to 300° C.

### Example 15

A composite magnetic material was produced in the same manner as in Example 1, except that the heat treatment temperature in H₂ in the fourth step of Example 1 was changed to 500° C.

### Example 16

A composite magnetic material was produced in the same manner as in Example 1, except that the heat treatment temperature in H₂ in the fourth step of Example 1 was changed to 800° C.

### Comparative Example 7

A composite magnetic material was produced in the same manner as in Example 1, except that the heat treatment temperature in H₂ in the fourth step of Example 1 was changed to 30° C.

### Comparative Example 8

A composite magnetic material was produced in the same manner as in Example 1, except that the heat treatment temperature in H₂ in the fourth step of Example 1 was changed to 900° C.

The results of the above evaluations are summarized in Table 3 and Table 4.

TABLE 3

| | Magnetic particles (particle aggregates) | | | | | | | | | | |
|---|---|---|---|---|---|---|---|---|---|---|---|
| | Constitution | | | | Magnetic metal nanoparticles | | | | | | |
| | | Average | Average | | | | Particle | CV | Packing | Average | Interstitial |
| | | height | aspect | Resistivity | | | size | value | ratio | interparticle | phase |
| | Shape | (μm) | ratio | (μΩ · cm) | Shape | Composition | (nm) | (%) | (vol %) | distance (nm) | Composition |
| Example 9 | Flat | 0.06 | 230 | 700 | Spherical | Fe—Ni—Si | 6 | 27 | 55 | 1 | Si—FeNi—O |
| | Shape | | | | shape | | | | | | |
| Example 10 | Flat | 0.07 | 220 | 600 | Spherical | Fe—Ni—Si | 7 | 28 | 55 | 1 | Si—FeNi—O |
| | Shape | | | | shape | | | | | | |
| Example 11 | Flat | 0.07 | 220 | 600 | Spherical | Fe—Ni—Si | 7 | 26 | 55 | 1 | Si—FeNi—O |
| | Shape | | | | shape | | | | | | |
| Example 12 | Flat | 0.08 | 200 | 300 | Spherical | Fe—Ni—Si | 8 | 30 | 55 | 1 | Si—FeNi—O |
| | Shape | | | | shape | | | | | | |
| Example 13 | Flat | 0.06 | 240 | 700 | Spherical | Fe—Ni—Si | 6 | 25 | 55 | 1 | Si—FeNi—O |
| | Shape | | | | shape | | | | | | |
| Example 14 | Flat | 0.07 | 220 | 600 | Spherical | Fe—Ni—Si | 7 | 28 | 55 | 1 | Si—FeNi—O |
| | Shape | | | | shape | | | | | | |
| Example 15 | Flat | 0.07 | 210 | 600 | Spherical | Fe—Ni—Si | 7 | 29 | 55 | 1 | Si—FeNi—O |
| | Shape | | | | shape | | | | | | |
| Example 16 | Flat | 0.09 | 160 | 200 | Spherical | Fe—Ni—Si | 10 | 35 | 55 | 1 | Si—FeNi—O |
| | Shape | | | | shape | | | | | | |
| Comparative | Flat | 0.06 | 230 | 700 | Spherical | Fe—Ni—Si | 8 | 51 | 55 | 1 | Si—FeNi—O |
| Example 5 | Shape | | | | shape | | | | | | |
| Comparative | Flat | 0.12 | 90 | 90 | Spherical | Fe—Ni—Si | 12 | 55 | 55 | 1 | Si—FeNi—O |
| Example 6 | Shape | | | | shape | | | | | | |
| Comparative | Flat | 0.06 | 230 | 700 | Spherical | Fe—Ni—Si | 6 | 52 | 55 | 1 | Si—FeNi—O |
| Example 7 | Shape | | | | shape | | | | | | |
| Comparative | Flat | 0.14 | 80 | 70 | Spherical | Fe—Ni—Si | 15 | 58 | 55 | 1 | Si—FeNi—O |
| Example 8 | Shape | | | | shape | | | | | | |

TABLE 4

| | Characteristics of high frequency magnetic material | | | | | |
|---|---|---|---|---|---|---|
| | Real part of | Magnetic | Change ratio over time in | | Yield of | |
| | magnetic | permeability | real part of magnetic | | change ratio | |
| | permeability, | loss, μ · tanδ | permeability, μ′ (10 MHz), | μ′ yield | over time | Strength |
| | μ′ (10 MHz) | (%) (10 MHz) | after 60° C. and 100 hr | (%) | (%) | ratio |
| Example 9 | 19 | <0.05 | 0.98 | 76 | 72 | 1.2 |
| Example 10 | 20 | <0.05 | 0.98 | 76 | 73 | 1.3 |
| Example 11 | 20 | <0.05 | 0.98 | 79 | 74 | 1.3 |
| Example 12 | 18 | <0.05 | 0.97 | 75 | 71 | 1.2 |
| Example 13 | 18 | <0.05 | 0.98 | 75 | 70 | 1.2 |
| Example 14 | 19 | <0.05 | 0.98 | 76 | 71 | 1.3 |
| Example 15 | 19 | <0.05 | 0.98 | 75 | 72 | 1.3 |
| Example 16 | 17 | <0.05 | 0.93 | 73 | 69 | 1.2 |
| Comparative | 12 | 0.05~0.1 | 0.93 | 40 | 39 | 1.0 |
| Example 5 | | | | | | |
| Comparative | 11 | 0.05~0.1 | 0.91 | 35 | 34 | 0.9 |
| Example 6 | | | | | | |
| Comparative | 12 | 0.05~0.1 | 0.92 | 36 | 36 | 1.0 |
| Example 7 | | | | | | |
| Comparative | 10 | 0.05~0.1 | 0.90 | 32 | 32 | 0.9 |
| Example 8 | | | | | | |

It is contemplated in regard to the materials of Examples 9 to 16 that flattening and compositization proceed efficiently, a more uniform and homogeneous structure having a smaller particle size (magnetic metal nanoparticles of the first magnetic metal phase) with less strain can be realized, and excellent magnetic characteristics (real part of magnetic permeability, magnetic permeability loss, change ratio over time, and yield) and excellent mechanical characteristics (strength and toughness) can be realized. Furthermore, excellent magnetic characteristics and mechanical characteristics can be obtained from Examples 9 to 16 by setting the heat treatment temperature in the second step and the heat treatment temperature in the fourth step to the range of from 50° C. to 800° C.; however, it is understood that more preferably, the characteristics are further enhanced by setting the heat treatment temperatures to a temperature of from 300° C. to 500° C. Also, in regard to the saturation magnetization, all of the materials realized high saturation magnetization of 0.7 T or higher.

In fact, as is obvious from Table 4, it is understood that the composite magnetic materials related to Examples 9 to 16 are excellent in all of the real part of magnetic permeability, the magnetic permeability loss, the change ratio over time, the μ′ yield (%), the yield of the change over time (%), and the strength ratio as compared with the materials of Comparative Examples 5 to 8.

While certain embodiments have been described, these embodiments have been presented by way of example only, and are not intended to limit the scope of the inventions. Indeed, the method for producing a composite magnetic material described herein may be embodied in a variety of other forms; furthermore, various omissions, substitutions and changes in the form of the devices and methods described herein may be made without departing from the spirit of the inventions. The accompanying claims and their equivalents are intended to cover such forms or modifications as would fall within the scope and spirit of the inventions.

What is claimed is:

1. A method for producing a magnetic material, the method comprising:
preparing a mixed phase material including a first magnetic metal phase formed from a magnetic metal and a second phase containing any one of oxygen (O), nitrogen (N) or carbon (C) and a non-magnetic metal;
conducting a first heat treatment to the mixed phase material at a temperature of from 50° C. to 800° C.;
forming nanoparticle aggregates including a plurality of magnetic metal nanoparticles formed from the first magnetic metal phase and the second phase, the nanoparticle aggregates being formed by decreasing an average particle size and a particle size distribution variation of the first magnetic metal phase after the first heat treatment; and
conducting a second heat treatment to the nanoparticle aggregates at a temperature of from 50° C. to 800° C.

2. The method according to claim 1, further comprising:
repeating, at least one time, after conducting the second heat treatment to the nanoparticle aggregates at the temperature of from 50° C. to 800° C.,
forming the nanoparticle aggregates after the second heat treatment, the nanoparticle aggregates being formed by decreasing the average particle size and the particle size distribution variation of the first magnetic metal phase after the second heat treatment; and
conducting a heat treatment to the nanoparticle aggregates at a temperature of from 50° C. to 800° C.

3. The method according to claim 1, wherein in the mixed phase material, the first magnetic metal phase is formed from a plurality of magnetic metal particles, and the second phase is formed from a plurality of particles.

4. The method according to claim 1, wherein in the mixed phase material, the first magnetic metal phase is formed from a plurality of magnetic metal particles, and the second phase is a coating layer covering the magnetic metal particles.

5. The method according to claim 1, wherein the mixed phase material is formed from particle aggregates having a particulate shape, the first magnetic metal phase is formed from a plurality of magnetic metal particles disposed within the particle aggregates, and the second phase is disposed around the magnetic metal particles within the particle aggregates.

6. The method according to claim 1, wherein the mixed phase material is formed from particle aggregates having a particulate shape, the second phase is formed from a plurality of particles disposed within the particle aggregates, and the first magnetic metal phase is disposed around the particles within the particle aggregates.

7. The method according to claim 5, wherein the average particle size of the particle aggregates is from 10 nm to 10 μm, the average particle size of the magnetic metal particles of the first magnetic metal phase included in the particle aggregates is from 1 nm to 100 nm,
the average short dimension of the nanoparticle aggregates is from 10 nm to 2 μm, the average aspect ratio is from 5 to 1000, and the average particle size of the magnetic metal nanoparticles of the first magnetic metal phase included in the nanoparticle aggregates is from 1 nm to 20 nm.

8. The method according to claim 5, wherein the average short dimension of the particle aggregates is larger than the average short dimension of the magnetic material, the average aspect ratio of the particle aggregates is more than or equal to 1 but less than 5 and is smaller than the average aspect ratio of the nanoparticle aggregates, and the average particle size of the magnetic metal particles of the first magnetic metal phase included in the particle aggregates is larger than the average particle size of the magnetic metal nanoparticles of the first magnetic metal phase included in the nanoparticle aggregates.

9. The method according to claim 1, wherein the first magnetic metal phase includes at least one selected from the group consisting of iron (Fe), cobalt (Co) and nickel (Ni), and the second phase includes any one of oxygen (O), nitrogen (N) or carbon (C), and at least one non-magnetic metal selected from magnesium (Mg), aluminum (Al), silicon (Si), calcium (Ca), zirconium (Zr), titanium (Ti), hafnium (Hf), zinc (Zn), manganese (Mn), barium (Ba), strontium (Sr), chromium (Cr), molybdenum (Mo), silver (Ag), gallium (Ga), scandium (Sc), vanadium (V), yttrium (Y), niobium (Nb), lead (Pb), copper (Cu), indium (In), tin (Sn) and rare earth elements.

10. The method according to claim 1, wherein the first magnetic metal phase includes at least one non-magnetic metal selected from Mg, Al, Si, Ca, Zr, Ti, Hf, Zn, Mn, Ba, Sr, Cr, Mo, Ag, Ga, Sc, V, Y, Nb, Pb, Cu, In, Sn, and rare earth elements.

11. The method according to claim 10, wherein the second phase includes at least one of the magnetic metals and at least one of the non-magnetic metals constituting one of the constituent elements of the first magnetic metal phase.

12. The method according to claim 1, wherein the non-magnetic metal is contained at a proportion of from 2 wt % to 5 wt % with respect to the magnetic metal, and oxygen is contained in an amount of from 3 wt % to 7 wt % relative to the total amount of the nanoparticle aggregates.

13. The method according to claim 1, wherein the first magnetic metal phase contains at least one additive metal different from the non-magnetic metal and selected from boron (B), silicon (Si), carbon (C), titanium (Ti), zirconium (Zr), hafnium (Hf), niobium (Nb), tantalum (Ta), molybdenum (Mo), chromium (Cr), copper (Cu), tungsten (W), phosphorus (P), nitrogen (N) and gallium (Ga), in an amount of from 0.001 atom % to 25 atom % relative to the total amount of the magnetic metal, the non-magnetic metal and the additive metal, and at least two of the magnetic metal, the non-magnetic metal and the additive metal form a solid solution of each other.

14. The method according to claim 1, wherein the volume packing ratio of the magnetic metal nanoparticles is from 40 vol % to 80 vol % relative to the total amount of the nanoparticle aggregates.

15. The method according to claim 1, wherein the crystal structure of the first magnetic metal phase is a hexagonal crystal structure.

16. The method according to claim 1, wherein in preparing the mixed phase material, the mixed phase material is prepared by applying a gravitational acceleration of from 40 G to 1000 G to a raw material powder of the first magnetic metal phase and a raw material powder of the second phase.

17. The method according to claim 1, wherein in preparing the mixed phase material, the mixed phase material is prepared by applying a gravitational acceleration of more than or equal to 10 G but less than 40 G to a raw material powder of the first magnetic metal phase and a raw material powder of the second phase.

18. The method according to claim 1, wherein in preparing the mixed phase material, the mixed phase material is prepared by applying a gravitational acceleration of from 10 G to 1000 G to an alloy ribbon including the first magnetic metal phase and the non-magnetic metal.

19. The method according to claim 1, wherein the crystal strain of the first magnetic metal phase of the nanoparticle aggregates is from 0.001% to 0.3%.

20. The method according to claim 1, wherein the coefficient of variation of the particle size variation of the first magnetic metal phase of the nanoparticle aggregates is from 0.1% to 40%.
